(19) United States
(12) Patent Application Publication
(10) Pub. No.: US 2026/0257280 A1
(43) Pub. Date: Sep. 3, 2026

(54) A SYSTEM AND METHOD FOR HOLDING A CUTTING INSERT, AND A CUTTING INSERT FOR USE THEREWITH

(71) Applicant: No Screw Ltd., Hevel Modi'in (IL)

(72) Inventor: Gershon HARIF, Ramat Gan (IL)

(21) Appl. No.: 19/491,237

(22) PCT Filed: May 7, 2024
(86) PCT No.: PCT/IL2024/050435

§ 371 Date: Dec. 8, 2025

(30) Foreign Application Priority Data
Jun. 15, 2023 (IL) 303781

(51) Int. Cl. B23B 27/16

(52) U.S. Cl. CPC B23B 27/164; B23B 27/1651; B23B 2200/081; B23B 2200/088; B23B 2260/03; B23B 2260/136

(57) ABSTRACT

A cutting tool holder (102, 104, 10B, 11B, 19B) system for mounting thereon a cutting insert (124, 500, 560, 800) comprising a tool holder (102, 104, 10B, 11B, 19B), a clamp (128) that is rotatable with respect to the tool holder between a clamping position, in which the clamp (128) clamps down on the cutting insert (124, 500, 560, 800) and an unclamping position, in which the clamp (128) allows the removal of the insert (124, 500, 560) from a seat (120), a compression unit (150) exerting a clamping force (154, 174, 590) in the clamping position, and a rotation unit (130) for enabling a user to rotate the clamp (128) by hand.

### TECHNOLOGICAL FIELD

The presently disclosed subject matter relates to a cutting tool holder system operative for securely mounting a cutting insert for performing a cutting operation, and more particularly for a cutting tool holder system comprising a cutting tool holder and a clamp operative to clamp the cutting insert within the cutting tool holder.

### BACKGROUND

One example of a cutting tool holder of the kind used in a device to which the presently disclosed subject matter refers, is disclosed in U.S. Pat. No. 10,500,647 of the present Applicant.

Cutting tool holders typically house a cutting insert seated therein and are adapted for the removal of material from a workpiece during a cutting operation e.g. milling, drilling and turning. Many tool holders may comprise a plurality of cutting inserts, each formed with at least one, two or more cutting edges.

To withstand the relatively high working loads during operation, the cutting inserts are normally manufactured from an expensive and high-quality hard metal alloy. Thus, the cutting inserts may be shaped to be as small as possible to save costs.

Typically, the cutting inserts are firmly secured to the seat of the cutting tool holder to prevent inadvertent release of the cutting insert from the seat during the high load cutting operation. In conventional cutting tool holders, the cutting insert is attached within the seat of the cutting tool holder by a fastener passing through a bore in the cutting insert into the bottom of the seat of the cutting tool holder and/or is clamped by use of a clamping member to the seat which requires designated tools to apply relatively high forces to unclamp the clamping member for removal of the cutting insert from the seat.

Due to the high working loads during the cutting operation, the cutting edges of cutting inserts wear rapidly, particularly when cutting hard materials such as metal, and therefore require frequent replacement or resharpening. Indexing or complete replacement of the conventionally secured cutting insert, requires the removal of the fastener, the reorientation or removal of the cutting insert, and the reattachment of the cutting insert within the seat of the cutting tool by the fastener. Each of these operations is arduous and time-consuming, particularly whereupon a plurality of such cutting inserts require indexing. Additionally, when the cutting inserts are clamped to the seat, unclamping the cutting inserts requires use of tools, e.g. a torque wrench, a hexagon wrench, or the like, to overcome the high clamping forces.

### GENERAL DESCRIPTION

According to a first aspect of the presently disclosed subject matter, there is provided a cutting tool holder system operative for securely mounting thereon a cutting insert for performing a cutting operation thereby, said cutting tool holder system, at least when assembled for operation, comprising: a cutting tool holder having a body with a seat configured for mounting the cutting insert thereon; a clamp having a cutting insert-engaging portion and rotatably mounted to the cutting tool holder, the clamp being rotatably maneuverable between a clamping position, in which the clamp is operable to apply a clamping force at least on the cutting insert positioned within the seat for preventing removal of the cutting insert from the seat, and an unclamping position, in which the clamp allows the removal of the insert from the seat; a compression unit configured for facilitating application of a compression force on the clamp towards the cutting tool holder, to enable the clamp to apply said clamping force at least while the clamp is positioned in the clamping position; and a rotation unit configured for enabling the clamp to move in a rotating motion with respect to the cutting tool holder between the clamping position and the unclamping position, by application of a rotational force of a magnitude compatible with that of a user's manual force.

In some examples, the compression unit can be operable to be compressed to a first extent while the clamp is positioned in the clamping position and to be compressed to a second extent, while the clamp is positioned in the unclamping position, and the second extent is similar or greater than the first extent.

In some examples, the compression unit can comprise any one of a compression spring element, a piston, a mechanical fastener and a ratchet mechanism.

In some examples, the body of the cutting tool holder can be formed with a cavity therein, wherein the compression unit is positioned at least partially within the cavity.

In some examples, the cavity can have a wide portion forming a peripheral first shoulder and extending to a narrow portion forming a peripheral second shoulder, wherein the compression unit is confined at least partially intermediate the peripheral first shoulder and the peripheral second shoulder.

In some examples, the body of the cutting tool holder can have a clamp-facing surface facing the clamp, wherein the cutting insert-engaging portion of the clamp is configured to be elevated above the clamp-facing surface during rotation of the clamp.

In some examples, the cutting tool holder system can further comprise an elevation arrangement for elevating the cutting insert-engaging portion.

In some examples, the elevation arrangement can comprise at least one of: an inclined surface positioned at least partially codirectionally with at least a part of the rotational motion of the clamp when maneuvered between the clamping position and the unclamping position and configured to engage a vertically adjacent surface; and a vertically adjacent surface configured to engage an inclined surface so as to advance therealong on the inclined surface during the rotational motion. It is to be understood herein that in some examples, the elevation arrangement can comprise one of the an inclined surface and the vertically adjacent surface, while the other one of the vertically adjacent surface and the inclined surface is positioned on the cutting insert.

In some examples, the inclined surface can be sloped so as to increasingly rise in a direction extending from the clamp-facing surface to the clamp and codirectionally with at least a part of the rotational motion of the clamp when maneuvered from the clamping position towards the unclamping position.

In some examples, the inclined surface can be defined on the clamp or at the cutting tool holder and the vertically adjacent surface can be defined at the oppositely positioned cutting tool holder or the clamp.

In some examples, the clamp can define a lower surface facing the cutting tool holder, and wherein the inclined surface can be positioned at any one of: the at the lower surface and the clamp-facing surface.

In some examples, one of the inclined surface and the vertically adjacent surface can be defined on the cutting insert-engaging portion.

In some examples, the cutting tool holder system can further comprise the cutting insert, and the other one of the inclined surface and the vertically adjacent surface can be defined on the cutting insert.

In some examples, the inclined surface can comprise a deeper region associated with the clamping position of the clamp and a superficial region associated with the unclamping position of the clamp, and the vertically adjacent surface can comprise at least one protrusion protruding towards the inclined surface.

In some examples, when the clamp is positioned at the clamping position the protrusion can be disposed in the deeper region and when the clamp is positioned at the unclamping position the protrusion can be disposed at the superficial region or closer to the superficial region than to the deeper region.

In some examples, the inclined surface can have a curvature about an axis of rotation of the clamp, the curvature of the inclined surface being different from a curvature of the rotating motion of the clamp about the axis of rotation.

In some examples, the curvature of the inclined surface can cause the clamp to at least tend to move in a direction extending from the seat towards a body rear section of the body during rotation of the clamp from the unclamping position to the clamping position.

In some examples, the cutting insert-engaging portion can comprise a projection extending towards the insert.

In some examples, the clamp can be formed with at least one depression configured for positioning the user's finger on the clamp so as to apply the rotational force utilizing the user's manual force.

In some examples, the rotational motion is operable by application of the user's manual force without use of a tool.

In some examples, the clamp can comprise a clamp-rear portion, which can be located horizontally opposite the cutting insert-engaging portion, and the body can comprises a body-rear portion which is located horizontally opposite the seat, and whereas an extension can extend from one of the clamp-rear portion and the body-rear portion and is configured to slidably move along the other one of the body-rear portion and the clamp-rear portion during the rotatable motion. In some examples, the other one of the body-rear portion and the clamp-rear portion can comprise a groove having a wall and the wall is configured for the slidable movement of the extension during the rotatable motion.

In some examples, the groove can have a curvature about an axis of rotation of the clamp, said curvature of the groove being different from a curvature of the rotating motion of the clamp about the axis of rotation.

In some examples, the curvature of the groove can cause the clamp to at least tend to move in a direction extending from the seat towards a body rear section of the body during rotation of the clamp from the unclamping position to the clamping position.

In some examples, the clamp can be formed with a bore positioned substantially orthogonally to the clamp-facing surface and in alignment with the cavity.

In some examples, the rotation unit can comprise an axle operable to be inserted within the bore and the cavity, and the axle is configured for rotating the clamp in the rotatable motion.

In some examples, the clamp can comprise a fastening member configured for fastening the axle to the clamp in proximity to an upper end of the axle.

In some examples, the compression unit can comprises a supporting member having an upper side and an underside, and a compression element, the compression element is mounted at the upper side of the supporting member.

In some examples, the axle can be formed with an enlarged head at a lower end thereof and the head is arranged to abut against the underside of the supporting member.

In some examples, the compression element can be compressed at least to the first extent by fastening the axle to the fastening member.

In some examples, the rotation unit can comprise a low friction member for mitigating friction resulting from the compression force applied on the clamp by the compression unit, thereby facilitating the rotational motion. In some examples, the low friction member can comprises any one of a static bearing surface, a rotatable bearing, a ball-bearing, a gear, and a belt.

In some examples, the cutting tool holder system can further comprise a cutting insert.

In some examples, the rotation unit can comprise a helical rotation unit configured for enabling the clamp to move in a helical rotating motion with respect to the cutting tool holder between the clamping position and the unclamping position, by application of the rotational force, the helical motion vertically distancing the cutting insert-engaging portion from the body.

According to a second aspect of the presently disclosed subject matter, there is provided a cutting insert configured to be mounted within a seat formed within a body of a cutting tool holder, the body being formed with a clamp-facing surface and configured to face a clamp having a cutting insert-engaging portion and rotatably engaged with the cutting tool holder, the clamp being rotatably maneuverable between a clamping position, for preventing removal of the cutting insert from the seat, and an unclamping position for enabling the removal of the cutting insert from the seat, the cutting insert comprising: an insert top surface having a horizontal axis and a lateral axis; and a first mounting element formed on the insert top surface and configured to engage with a second mounting element formed on the clamp for mounting the cutting insert within the seat, said first mounting element comprising one of: a recess formed in the insert top surface and configured to at least partially engage with a corresponding protrusion formed on the clamp, said recess being curved about an axis perpendicular to the insert top surface, and a protrusion protruding from the insert top surface and configured to at least partially engage with a corresponding recess formed on the clamp.

In some examples, the protrusion can have a height dimensioned to least partially protrude axially above the clamp-facing surface of the body whereupon the cutting insert is seated within the seat.

In some examples, the protrusion can be a central protrusion protruding from a midpoint of the insert top surface along at least one of the horizontal axis and the lateral axis.

In some examples, the protrusion can have a lateral wall comprising a curved surface.

In some examples, the protrusion can be monolithically formed with the cutting insert.

In some examples, the cutting insert can have an insert bottom surface and further comprises another protrusion protruding from the insert bottom surface.

In some examples, the recess can comprise a depression configured to lock therewithin the corresponding protrusion formed on the clamp.

In some examples, the depression can have inclined walls configured to guide the corresponding protrusion formed on the clamp into the depression in an event of inadvertent movement of the corresponding protrusion formed on the clamp.

In some examples, the inclined walls can be configured to guide the corresponding protrusion formed on the clamp out of the depression upon application of rotational force on the clamp for maneuvering the clamp from the clamping position to the unclamping position.

According to a third aspect of the presently disclosed subject matter, there is provided a cutting tool holder system operative for securely mounting thereon a cutting insert for performing a cutting operation thereby, said cutting tool holder system comprising: a cutting insert comprising: an insert top surface; and a first mounting element formed on the insert top surface; a tool holder formed with a seat; and a clamp having a cutting insert-engaging portion and rotatably engaged with the tool holder, the clamp being rotatably maneuverable between a clamping position, in which the clamp is operable to apply a clamping force at least on the cutting insert positioned within the seat for preventing removal of the insert from the seat, and an unclamping position, in which the clamp allows the removal of the insert from the seat, said clamp comprising a second mounting element formed on an underside facing surface of the cutting insert-engaging portion facing the cutting insert, said second mounting element being configured to engage with the first mounting element formed on the cutting insert for mounting the cutting insert within the seat; wherein the first mounting element comprises one of: a recess formed in the insert top surface and configured to at least partially engage with a corresponding protrusion formed on the clamp, said recess being curved about an axis perpendicular to the insert top surface, and a protrusion protruding from the insert top surface and configured to at least partially engage with a corresponding recess formed on the clamp; and wherein the second mounting element comprises one of: a protrusion protruding from the underside facing surface and configured to at least partially engage with a corresponding recess formed on the insert top surface, and a recess formed in the underside facing surface and configured to at least partially engage with a corresponding protrusion formed on the insert top surface.

In some examples, the recess can comprise a depression configured to lock therewithin the corresponding protrusion.

In some examples, the depression can have inclined walls configured to guide the corresponding protrusion into the depression in an event of inadvertent movement of the corresponding protrusion.

In some examples, the inclined walls can be configured to guide the corresponding protrusion out of the depression upon application of rotational force on the clamp for maneuvering the clamp from the clamping position to the unclamping position.

According to a fourth aspect of the presently disclosed subject matter, there is provided a method for selectively mounting a cutting insert on a seat formed within a body of a cutting tool holder during a clamping mode and dismounting the cutting insert from the seat during an unclamping mode, the body being formed with a clamp-facing surface and configured to face a clamp having a cutting insert-engaging portion, the method comprising: seating the cutting insert in the seat; applying a compression force on the clamp towards the cutting tool holder during both the clamping mode and the unclamping mode; clamping the cutting insert during the clamping mode to the seat by applying a clamping force via the cutting insert-engaging portion of the clamp at least on the cutting insert, thereby preventing removal of the cutting insert from the seat, wherein the clamping force is facilitated by the compression force; unclamping the cutting insert during the unclamping mode by rotating the clamp with respect to the cutting tool holder with a rotational force of a magnitude compatible with that of a user's manual force.

### Embodiments

A more specific description is provided in the Detailed Description whilst the following are non-limiting examples of different embodiments of the presently disclosed subject matter.
1. A cutting tool holder system operative for securely mounting thereon a cutting insert for performing a cutting operation thereby, said cutting tool holder system, at least when assembled for operation, comprising:
   (a) a cutting tool holder having a body with a seat configured for mounting the cutting insert thereon;
   (b) a clamp having a cutting insert-engaging portion and rotatably mounted to the cutting tool holder, the clamp being rotatably maneuverable between a clamping position, in which the clamp is operable to apply a clamping force at least on the cutting insert positioned within the seat for preventing removal of the cutting insert from the seat, and an unclamping position, in which the clamp allows the removal of the insert from the seat;
   (c) a compression unit configured for facilitating application of a compression force on the clamp towards the cutting tool holder, to enable the clamp to apply said clamping force at least while the clamp is positioned in the clamping position; and
   (d) a rotation unit configured for enabling the clamp to move in a rotating motion with respect to the cutting tool holder between the clamping position and the unclamping position, by application of a rotational force of a magnitude compatible with that of a user's manual force.
2. The cutting tool holder system according to embodiment 1, wherein the compression unit is operable to be compressed to a first extent while the clamp is positioned in the clamping position and to be compressed to a second extent, while the clamp is positioned in the unclamping position, and the second extent is similar or greater than the first extent.
3. The cutting tool holder system according to any one of the previous embodiments, wherein the compression unit comprises any one of a compression spring element, a piston, a mechanical fastener and a ratchet mechanism.
4. The cutting tool holder system according to any one of the previous embodiments wherein the body of the cutting tool holder is formed with a cavity therein, wherein the compression unit is positioned at least partially within the cavity.
5. The cutting tool holder system according to embodiment 4, wherein the cavity has a wide portion forming a peripheral first shoulder and extending to a narrow portion forming a peripheral second shoulder, wherein the compression unit is confined at least partially intermediate the peripheral first shoulder and the peripheral second shoulder.
6. The cutting tool holder system according to any one of the previous embodiments, wherein the body of the cutting tool holder has a clamp-facing surface facing the clamp, wherein the cutting insert-engaging portion of the clamp is configured to be elevated above the clamp-facing surface during rotation of the clamp.
7. The cutting tool holder system according to embodiment 6, further comprising an elevation arrangement for elevating the cutting insert-engaging portion.
8. The cutting tool holder system according to embodiment 7, the elevation arrangement comprising at least one of:
   an inclined surface positioned at least partially codirectionally with at least a part of the rotational motion of the clamp when maneuvered between the clamping position and the unclamping position and configured to engage a vertically adjacent surface; and
   a vertically adjacent surface configured to engage an inclined surface so as to advance therealong on the inclined surface during the rotational motion.
9. The cutting tool holder system according to embodiment 8, wherein the inclined surface is sloped so as to increasingly rise in a direction extending from the clamp-facing surface to the clamp and codirectionally with at least a part of the rotational motion of the clamp when maneuvered from the clamping position towards the unclamping position.
10. The cutting tool holder system according to embodiment 8 or 9, wherein the inclined surface is defined on the clamp or at the cutting tool holder and the vertically adjacent surface is defined at the oppositely positioned cutting tool holder or the clamp.
11. The cutting tool holder system according to embodiment 10, wherein the clamp defines a lower surface facing the cutting tool holder, and wherein the inclined surface is positioned at any one of: the at the lower surface and the clamp-facing surface.
12. The cutting tool holder according to embodiment 9, wherein one of the inclined surface and the vertically adjacent surface is defined on the cutting insert-engaging portion.
13. The cutting tool holder system according to embodiment 12, further comprising the cutting insert, wherein other one of the inclined surface and the vertically adjacent surface is defined on the cutting insert.
14. The cutting tool holder system according to any one of embodiments 8 to 13, wherein the inclined surface comprises a deeper region associated with the clamping position of the clamp and a superficial region associated with the unclamping position of the clamp, and the vertically adjacent surface comprises at least one protrusion protruding towards the inclined surface.
15. The cutting tool holder system according to embodiment 14, wherein when the clamp is positioned at the clamping position the protrusion is disposed in the deeper region and when the clamp is positioned at the unclamping position the protrusion is disposed at the superficial region or closer to the superficial region than to the deeper region.
16. The cutting tool holder system according to any one of embodiments 8 to 15, wherein the inclined surface has a curvature about an axis of rotation of the clamp, said curvature of the inclined surface being different from a curvature of the rotating motion of the clamp about the axis of rotation.
17. The cutting tool holder system according to embodiment 16, wherein the curvature of the inclined surface causes the clamp to at least tend to move in a direction extending from the seat towards a body rear section of the body during rotation of the clamp from the unclamping position to the clamping position.
18. The cutting tool holder system according to any one of the previous embodiments, wherein the cutting insert-engaging portion comprises a projection extending towards the insert.
19. The cutting tool holder system according to any one of the previous embodiments, wherein the clamp is formed with at least one depression configured for positioning the user's finger on the clamp so as to apply the rotational force utilizing the user's manual force.
20. The cutting tool holder system according to any one of the previous embodiments, wherein the rotational motion is operable by application of the user's manual force without use of a tool.
21. The cutting tool holder system according to any one of the previous embodiments, and wherein the clamp comprises a clamp-rear portion, which is located horizontally opposite the cutting insert-engaging portion, and the body comprises a body-rear portion which is located horizontally opposite the seat, and
   wherein an extension extends from one of the clamp-rear portion and the body-rear portion and is configured to slidably move along the other one of the body-rear portion and the clamp-rear portion during the rotatable motion.
22. The cutting tool holder system according to embodiment 21, wherein the other one of the body-rear portion and the clamp-rear portion comprises a groove having a wall and the wall is configured for the slidable movement of the extension during the rotatable motion.
23. The cutting tool holder system according to embodiment 22, wherein the groove has a curvature about an axis of rotation of the clamp, said curvature of the groove being different from a curvature of the rotating motion of the clamp about the axis of rotation.
24. The cutting tool holder system according to embodiment 23, wherein the curvature of the groove causes the clamp to at least tend to move in a direction extending from the seat towards a body rear section of the body during rotation of the clamp from the unclamping position to the clamping position.
25. The cutting tool holder system according to embodiment 4 or any one of embodiments 5-24 when dependent on embodiment 4, wherein the clamp is formed with a bore positioned substantially orthogonally to the clamp-facing surface and in alignment with the cavity.
26. The cutting tool holder system according to embodiment 25, wherein the rotation unit comprises an axle operable to be inserted within the bore and the cavity, and the axle is configured for rotating the clamp in the rotatable motion.
27. The cutting tool holder system according to embodiment 26, wherein the clamp comprises a fastening member configured for fastening the axle to the clamp in proximity to an upper end of the axle.
28. The cutting tool holder system according to embodiment 27, wherein the compression unit comprises:
   a supporting member having an upper side and an underside, and
   a compression element,
   the compression element is mounted at the upper side of the supporting member.
29. The cutting tool holder system according to embodiment 28, wherein the axle is formed with an enlarged head at a lower end thereof and the head is arranged to abut against the underside of the supporting member.
30. The cutting tool holder system according to any one of embodiments 28 or 29, when dependent on embodiment 2, wherein the compression element is compressed at least to the first extent by fastening the axle to the fastening member.
31. The cutting tool holder system according to any one of the previous embodiments, wherein the rotation unit comprises a low friction member for mitigating friction resulting from the compression force applied on the clamp by the compression unit, thereby facilitating the rotational motion.
32. The cutting tool holder system according to embodiment 31, wherein the low friction member comprises any one of a static bearing surface, a rotatable bearing, a ball-bearing, a gear, and a belt.
33. The cutting tool holder system according to any one of the previous embodiments, further comprising a cutting insert.
34. The cutting tool holder system according to any one of the previous embodiments, wherein the rotation unit comprises a helical rotation unit configured for enabling the clamp to move in a helical rotating motion with respect to the cutting tool holder between the clamping position and the unclamping position, by application of the rotational force, the helical motion vertically distancing the cutting insert-engaging portion from the body.
35. A cutting insert configured to be mounted within a seat formed within a body of a cutting tool holder, the body being formed with a clamp-facing surface and configured to face a clamp having a cutting insert-engaging portion and rotatably engaged with the cutting tool holder, the clamp being rotatably maneuverable between a clamping position, for preventing removal of the cutting insert from the seat, and an unclamping position for enabling the removal of the cutting insert from the seat, the cutting insert comprising:
   an insert top surface having a horizontal axis and a lateral axis; and
   a first mounting element formed on the insert top surface and configured to engage with a second mounting element formed on the clamp for mounting the cutting insert within the seat, said first mounting element comprising one of:
      a recess formed in the insert top surface and configured to at least partially engage with a corresponding protrusion formed on the clamp, said recess being curved about an axis perpendicular to the insert top surface, and
   a protrusion protruding from the insert top surface and configured to at least partially engage with a corresponding recess formed on the clamp.
36. The cutting insert according to embodiment 35, wherein the protrusion has a height dimensioned to least partially protrude axially above the clamp-facing surface of the body whereupon the cutting insert is seated within the seat.
37. The cutting insert according to embodiment 35 or 36, wherein the protrusion is a central protrusion protruding from a midpoint of the insert top surface along at least one of the horizontal axis and the lateral axis.
38. The cutting insert according to any one of embodiments 35 to 37, wherein the protrusion has a lateral wall comprising a curved surface.
39. The cutting insert according to any one of embodiments 35-38, wherein the protrusion is monolithically formed with the cutting insert.
40. The cutting insert according to any one of embodiments 35 to 39, wherein the cutting insert has an insert bottom surface and further comprises another protrusion protruding from the insert bottom surface.
41. The cutting insert according to any one of embodiments 35 to 40, wherein the recess comprises a depression configured to lock therewithin the corresponding protrusion formed on the clamp.
42. The cutting insert according to embodiment 41, wherein the depression has inclined walls configured to guide the corresponding protrusion formed on the clamp into the depression in an event of inadvertent movement of the corresponding protrusion formed on the clamp.
43. The cutting insert according to embodiment 42, wherein the inclined walls are configured to guide the corresponding protrusion formed on the clamp out of the depression upon application of rotational force on the clamp for maneuvering the clamp from the clamping position to the unclamping position.
44. A cutting tool holder system operative for securely mounting thereon a cutting insert for performing a cutting operation thereby, said cutting tool holder system comprising:
   a cutting insert comprising:
      an insert top surface; and
      a first mounting element formed on the insert top surface;
   a tool holder formed with a seat; and
   a clamp having a cutting insert-engaging portion and rotatably engaged with the tool holder, the clamp being rotatably maneuverable between a clamping position, in which the clamp is operable to apply a clamping force at least on the cutting insert positioned within the seat for preventing removal of the insert from the seat, and an unclamping position, in which the clamp allows the removal of the insert from the seat, said clamp comprising a second mounting element formed on an underside facing surface of the cutting insert-engaging portion facing the cutting insert, said second mounting element being configured to engage with the first mounting element formed on the cutting insert for mounting the cutting insert within the seat;
      wherein the first mounting element comprises one of:
      a recess formed in the insert top surface and configured to at least partially engage with a corresponding protrusion formed on the clamp, said recess being curved about an axis perpendicular to the insert top surface, and
      a protrusion protruding from the insert top surface and configured to at least partially engage with a corresponding recess formed on the clamp; and
      wherein the second mounting element comprises one of:
      a protrusion protruding from the underside facing surface and configured to at least partially engage with a corresponding recess formed on the insert top surface, and
   a recess formed in the underside facing surface and configured to at least partially engage with a corresponding protrusion formed on the insert top surface.
45. The cutting insert according to embodiment 44, wherein the recess comprises a depression configured to lock therewithin the corresponding protrusion.
46. The cutting insert according to embodiment 45, wherein the depression has inclined walls configured to guide the corresponding protrusion into the depression in an event of inadvertent movement of the corresponding protrusion.
47. The cutting insert according to embodiment 46, wherein the inclined walls are configured to guide the corresponding protrusion out of the depression upon application of rotational force on the clamp for maneuvering the clamp from the clamping position to the unclamping position.
48. A method for selectively mounting a cutting insert on a seat formed within a body of a cutting tool holder during a clamping mode and dismounting the cutting insert from the seat during an unclamping mode, the body being formed with a clamp-facing surface and configured to face a clamp having a cutting insert-engaging portion, the method comprising:
   (a) seating the cutting insert in the seat;
   (b) applying a compression force on the clamp towards the cutting tool holder during both the clamping mode and the unclamping mode;
   (c) clamping the cutting insert during the clamping mode to the seat by applying a clamping force via the cutting insert-engaging portion of the clamp at least on the cutting insert, thereby preventing removal of the cutting insert from the seat,
      wherein the clamping force is facilitated by the compression force;
   (d) unclamping the cutting insert during the unclamping mode by rotating the clamp with respect to the cutting tool holder with a rotational force of a magnitude compatible with that of a user's manual force.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a perspective view of a cutting tool holder system according to an embodiment of the presently disclosed subject matter;

FIG. 2 is an exploded view of the cutting tool holder system shown in FIG. 1;

FIGS. 3A and 3B are a perspective view (3A) of the cutting tool holder system of FIG. 1 and a sectional view (3B) taken along lines IIIB-IIIB in FIG. 3A, shown in a clamped operational mode;

FIGS. 4A and 4B are a perspective view (4A) of the cutting tool holder system of FIG. 1 and a sectional view (4B) taken along lines IVB-IVB in FIG. 4A, shown in an unclamped operational mode;

FIG. 5 is a perspective view of a cutting tool holder system according to an embodiment of the presently disclosed subject matter;

FIGS. 6A and 6B are a first exploded view (6A) and a second exploded view (6B) of the cutting tool holder system shown in FIG. 5;

FIGS. 7A and 7B are a perspective view (7A) of the cutting tool holder system of FIG. 5 and a sectional view (7B) taken along lines VIIB-VIIB in FIG. 7A, shown in a clamped operational mode;

FIGS. 8A and 8B are a perspective view (8A) of the cutting tool holder system of FIG. 5 and a sectional view (8B) taken along lines VIIIB-VIIIB in FIG. 8A, shown in an unclamped operational mode;

FIGS. 9A and 9B are perspective rear views of the cutting tool holder system of FIG. 5 shown in a clamped operational mode (FIG. 9A) and an unclamped operational mode (FIG. 9B);

FIGS. 10A-D are a perspective view of a clamp of the cutting tool holder system at an underside thereof (10A), a perspective view of a body of a cutting tool holder (10B), the cutting tool holder system at a clamped operational mode (FIG. 10C) and at an unclamped operational mode (FIG. 10D) according to an embodiment of the presently disclosed subject matter;

FIGS. 11A and 11B are a perspective view of a clamp of the cutting tool holder system at an underside thereof (11A) and a perspective view of a body of a cutting tool holder (11B) according to an embodiment of the presently disclosed subject matter;

FIGS. 12A-C are a perspective view of a spring support of the cutting tool holder system (12A) and the cutting tool holder system at a clamped operational mode (FIG. 12B) and at an unclamped operational mode (FIG. 12C) according to an embodiment of the presently disclosed subject matter;

FIGS. 13A and 13B are a perspective view of the cutting tool holder system at a clamped operational mode (FIG. 13A) and at an unclamped operational mode (FIG. 13B) according to an embodiment of the presently disclosed subject matter;

FIGS. 14A-C, are a perspective view of a cutting tool holder system (14A) and cross-sectional illustrations taken along lines XIVB-XIVB in FIG. 14A at a clamped operational mode (FIG. 14B) and at an unclamped operational mode (FIG. 14C) according to an embodiment of the presently disclosed subject matter;

FIGS. 15A-C, are a perspective view of a cutting tool holder system (15A) and cross-sectional illustrations taken along lines XVB-XVB in FIG. 15A at a clamped operational mode (FIG. 15B) and at an unclamped operational mode (FIG. 15C) according to an embodiment of the presently disclosed subject matter;

FIGS. 16A and 16B are a perspective view of a cutting tool holder system (16A) and a cross-sectional illustration taken along lines XVIB-XVIB in FIG. 16A at a clamped operational mode (FIG. 16B) according to an embodiment of the presently disclosed subject matter;

FIGS. 17A-C are a perspective view of a cutting tool holder system (17A), a partially exploded view of the cutting tool holder system of FIG. 17A (17B) and further exploded view of the cutting tool holder system (17C) at a clamped operational mode and its clamp being shown to be transparent, according to an embodiment of the presently disclosed subject matter; and

FIGS. 18A-G are perspective views of a cutting tool holder system in unclamping mode (18A), in an intermediate mode (18B), in another intermediate mode (18C), in clamping mode (18D), a cross-sectional illustration taken along lines XVIIIE-XVIIIE in FIG. 18B (18E), a cross-sectional illustration taken along lines XVIIIF-XVIIIF in FIG. 18C (18F), and a cross-sectional illustration taken along lines XVIIIG-XVIIIG in FIG. 18D (18G), according to an embodiment of the presently disclosed subject matter; and

FIGS. 19A-B are a perspective view of a clamp of the cutting tool holder system at an underside thereof (19A) and a perspective view of a body of a cutting tool holder (19B) according to an embodiment of the presently disclosed subject matter.

### DETAILED DESCRIPTION OF EMBODIMENTS

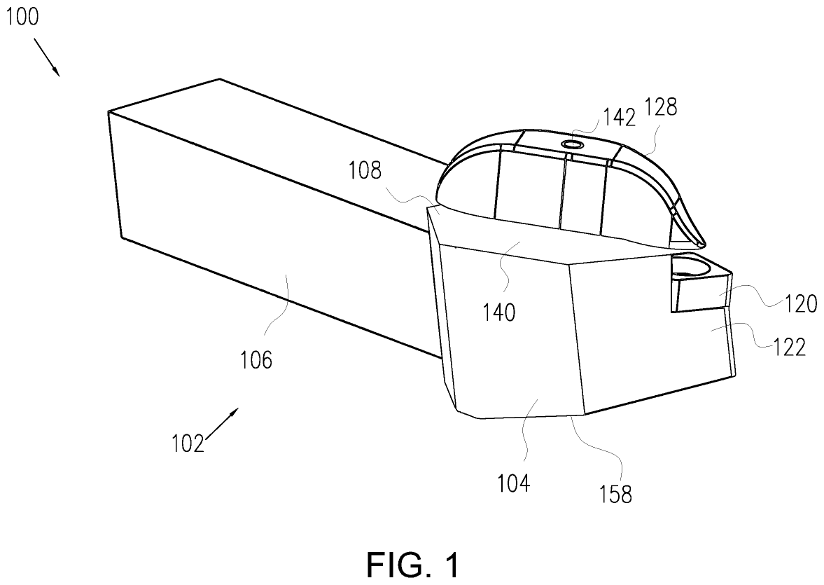

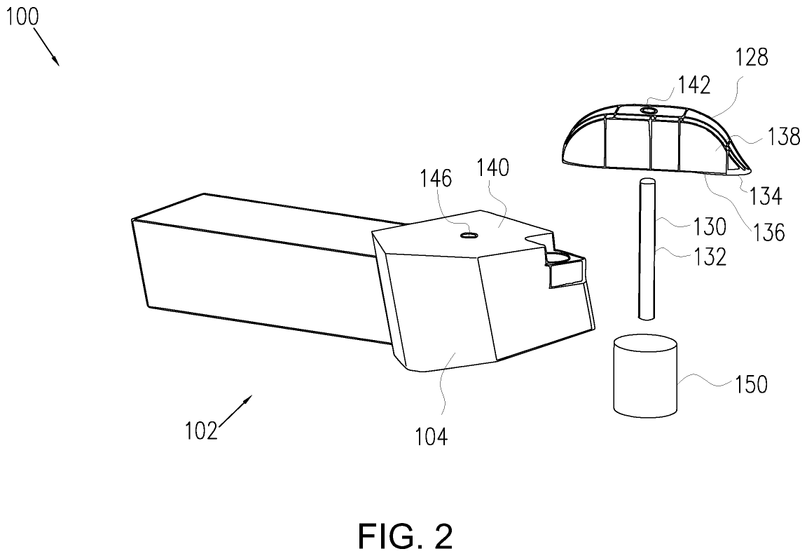

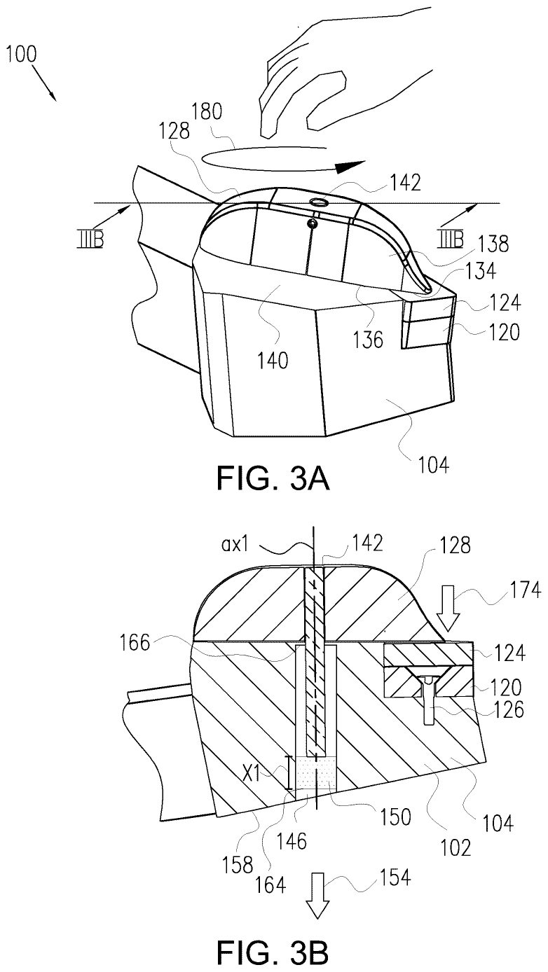

Reference is made to FIGS. 1 and 2, which are a perspective view of the cutting tool holder system 100 and an exploded view thereof, respectively. As seen in FIGS. 1 and 2, the cutting tool holder system 100 comprises a cutting tool holder 102 including a body 104 and a shank 106 extending from a rear section 108 of the body. The body 104 is formed with a seat 120 at a front section 122 thereof. The seat 120 is configured for mounting a cutting insert 124 (FIG. 3A) thereon.

Typically, the seat 120 is fixed to the body 104 by a central screw 126 (3B) or any other fastener inserted within the body 104 at its front section 122.

In general, the cutting insert 124 is securely mounted to the seat 120 by a clamp 128, which is rotatably engaged and/or mounted with the body 104, by any suitable means, such as by a rotation unit 130. In general, the rotation unit 130 comprises any suitable rotating element for rotatably engaging the clamp 128 with the body 104 and/or cutting insert 124.

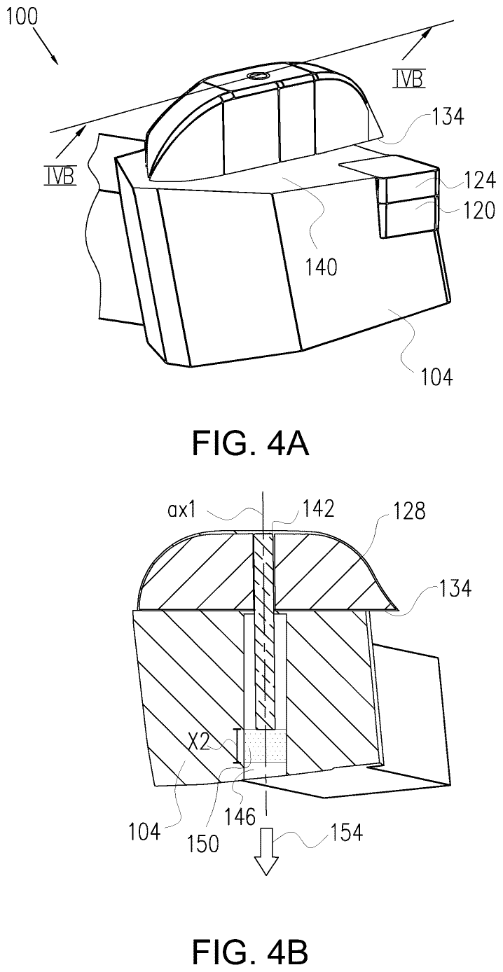

For example, the rotation unit 130 comprises an elongated element 132 engaged with the clamp 128 and operable for rotating the clamp 128 at least from a clamping position (interchangeably used herein with clamping mode or clamped operational mode) (FIGS. 3A and 3B) to an unclamping position (interchangeably used herein with unclamping mode or unclamped operational mode) (FIGS. 4A and 4B). At the clamping position a cutting insert-engaging portion 134 of the clamp 128 is engaged with the cutting insert 124 (FIG. 3A) for preventing removal of the cutting insert 124 from the seat 120. In general, the cutting insert-engaging portion 134 is defined at an underside surface 136 of the clamp 128 and at a front section 138 thereof.

It is noted that the cutting insert-engaging portion 134 may be defined at any location along the clamp 128.

To maneuver from the clamping position to the unclamping position, the elongated element 132 rotates the cutting insert-engaging portion 134 of the clamp 128, at least partially, away from the cutting insert 124 and optionally to a clamp-facing surface 140 of the body 104, thereby allowing removal of the cutting insert 124 from the seat 120.

In general, the rotation unit 130 may be disposed at any suitable location within the tool holder 102. For example, the elongated element 132 may be disposed along (e.g. parallel with) a longitudinal axis ax1 (FIG. 3B) of the clamp 128 and body 104 and may be at least partially inserted within a portion of the clamp 128 and a portion of the body 104.

In general, the elongated element 132 is inserted within a bore 142 formed within the clamp 128 and within a cavity 146 formed within body 104. For example, the clamp bore 142 and body cavity 146 may be mutually aligned and coaligned with longitudinal axis ax1.

In the shown example in FIG. 3B, the clamp bore 142, the body cavity 146 and the elongated element 132 inserted therein, are centrally disposed within the clamp 128 and the body 104 along longitudinal axis ax1.

It is to be understood herein that in all the examples described, the elongated element 132 and the clamp bore 142 are so dimensioned with respect to each other that there is a tolerance between the elongated element 132 and the clamp bore 142, allowing the elongated element 132 to move (no matter how small) within the clamp bore 142 in a direction other than the vertical direction along the axis of rotation (in addition to vertical movement). This tolerance allows the movement of the clamp with respect to the body in a direction other than the vertical direction along the axis of rotation (in addition to vertical movement), for example, tilting or pivoting movement caused by any of the elevation arrangement and horizontal force applying mechanism (described in detail later herein below).

The clamp 128, via a compression unit 150, is operable to apply a compression force (illustrated by arrow 154 in FIG. 3B) towards the cutting tool holder 102 in an axially downward orientation with respect to longitudinal axis ax1. In general, in accordance with an embodiment of the presently disclosed subject matter, the compression unit 150 is operable to apply the compression force 154 during the clamping mode, when the clamp 128 is in a clamping position, as well as during an unclamping mode, when the clamp 128 is in an unclamping position.

Reference is made to FIGS. 3A-4B, which are a perspective view and a sectional view of the cutting tool holder system 100 of FIG. 1 shown in a clamped operational mode (FIGS. 3A and 3B) and an unclamped operational mode (FIGS. 4A and 4B), respectively, and are shown with the cutting insert 124 mounted on the seat 120.

In general, the compression unit 150 is assembled within the body 104 (or clamp 128) intermediate a first barrier 164 and a second barrier 166 for maintaining the compression unit 150 under compression through both the clamping and unclamping modes. For example, the first barrier 164 and the second barrier 166 may be defined within the body cavity 146, as will be further described.

In general, the compression unit 150 is compressed to a first extent, e.g. measured by a first length X1, in FIG. 3B during the clamping mode, and to a second extent, e.g. measured by a second length X2 in FIG. 4B, during the unclamping mode. In the exemplary cutting tool holder system 100 of FIGS. 3A-4B, the compression lengths X1 and X2 are shown to be substantially similar, indicating that the compression force 154 of the compression unit 150 is at least maintained during at least the clamping and unclamping modes.

This compression force 154 applied to the clamp 128 causes the clamp 128 to apply a clamping force (illustrated by arrow 174 in FIG. 3B) at least in an axially downward orientation (with respect to longitudinal axis ax1 and parallel to compression force 154). During the clamping mode the insert-engaging portion 134 is contiguous (namely, in direct contact) with at least a portion of the cutting insert 124 and thus the clamping force 174 is applied to the cutting insert 124, which is therefore securely mounted within the seat 120.

In general, the rotation unit 130 facilitates rotation of the clamp 128 in a rotational motion, illustrated by arrow 180, from the clamping position shown in FIGS. 3A and 3B to the unclamping position shown in FIGS. 4A and 4B. Thereby disengaging, at least partially, the insert-engaging portion 134 from the cutting insert 124 to a degree sufficient for enabling the removal of the cutting insert 124 from the seat 120, for any of indexing, resharpening or replacement thereof.

For example, the clamp 128 is rotated to be at least partially in contact with the clamp-facing surface 140 of the body 104. In the exemplary embodiment shown in FIGS. 4A and 4B, the clamp 128 is shown to be entirely disengaged with the cutting insert 124 and to be at least partially positioned over, and optionally supported by, the clamp-facing surface 140 (e.g. entirely over the clamp-facing surface 140 and/or with part of the insert-engaging portion 134 suspended exteriorly from the body 104 and insert 124). In some examples, whole of the insert-engaging portion 134 can be suspended exteriorly from the body 104 and insert 124 and no part thereof engages or is positioned over the clamp facing surface 140.

In general, the magnitude of the applied clamping force 174 is selected to a degree which is sufficient for securely clamping the cutting insert 124 to the seat 120 during the clamping mode. In conventional systems release of such a force is typically performed by tensioning the compression unit and/or by axially lifting the clamp 128 in parallel to longitudinal axis ax1. This requires exertion of a relatively large magnitude of lifting force and must be performed with the aid of a tool, such as a wrench, in a non-limiting example. Yet, in accordance with an embodiment of the presently disclosed subject matter, maneuvering from the clamping mode to the unclamping mode and vice versa is facilitated by the aforementioned rotational motion 180. The magnitude of a torque, namely the rotational force, for performing the rotational motion 180 can be significantly less than the magnitude of the lifting force while achieving the same effect, to a degree that the torque magnitude can be compatible with that of a user's manual force. Accordingly, the rotational motion can be performed toollessly, by application of the user's manual force without use of a tool.

In conventional systems, the lifting force may be approximately 30 Kilograms or more, or the lifting force may be approximately 20 Kilograms or more, or the lifting force may be approximately 10 Kilograms or more, subranges and variables thereof.

In the shown example, the axis of rotation of the rotational motion 180 is the angular axis ax1.

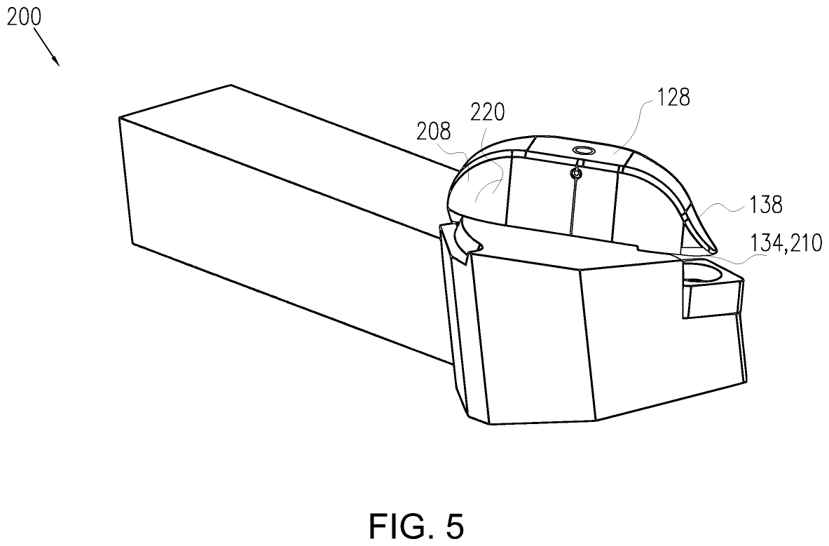

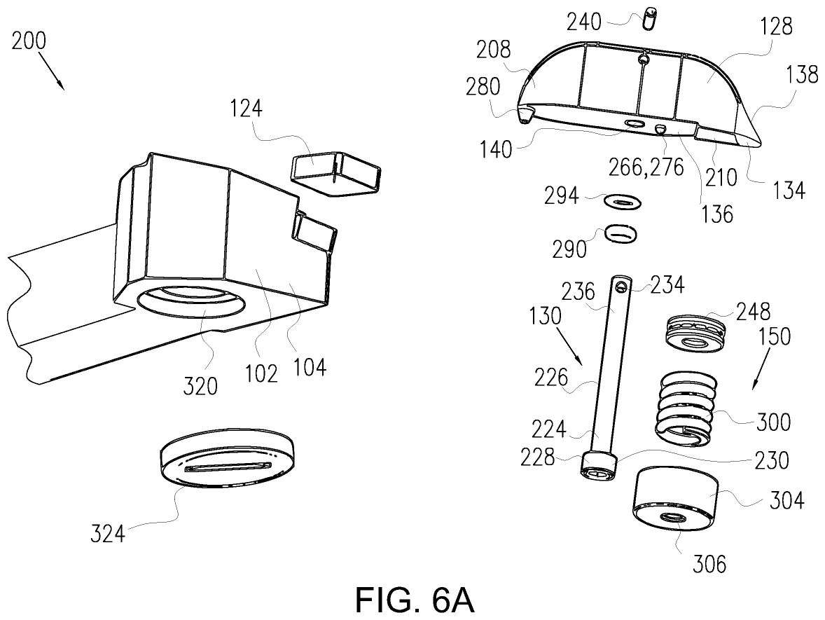

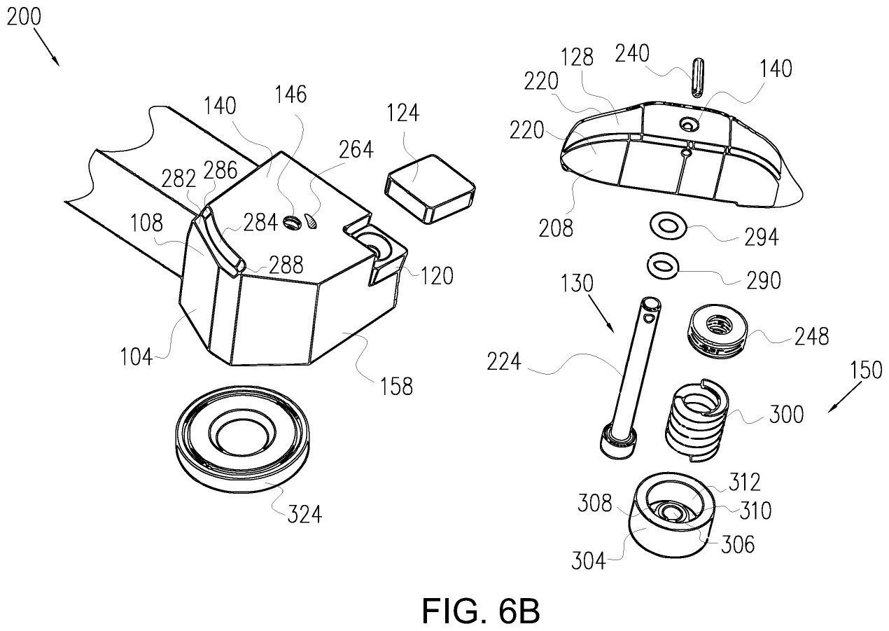

Reference is made to FIGS. 5-6B, which are a perspective view of a cutting tool holder system 200 (FIG. 5), a first exploded view (FIG. 6A) and a second exploded view (FIG. 6B), respectively. The cutting tool holder system 200 is as described in reference to cutting tool holder system 100 except where noted.

In the shown example, the clamp 128 is sized for ease of grasp thereof while rotating in the rotational motion 180. For example, the clamp 128 comprises an elongated body spanning from its front section 138 to a rear section 208 thereof. In the shown example, the clamp 128 is formed with a single or a pair of depressions 220 or more, which are configured for facilitating the positioning of the user's fingers on the clamp 128 so as to apply the rotational force by the user's manual force. It is to be understood herein that the description with respect to facilitating the positioning of the user's fingers on the clamp and ease of rotation therefore, apply to all the examples/embodiments described herein.

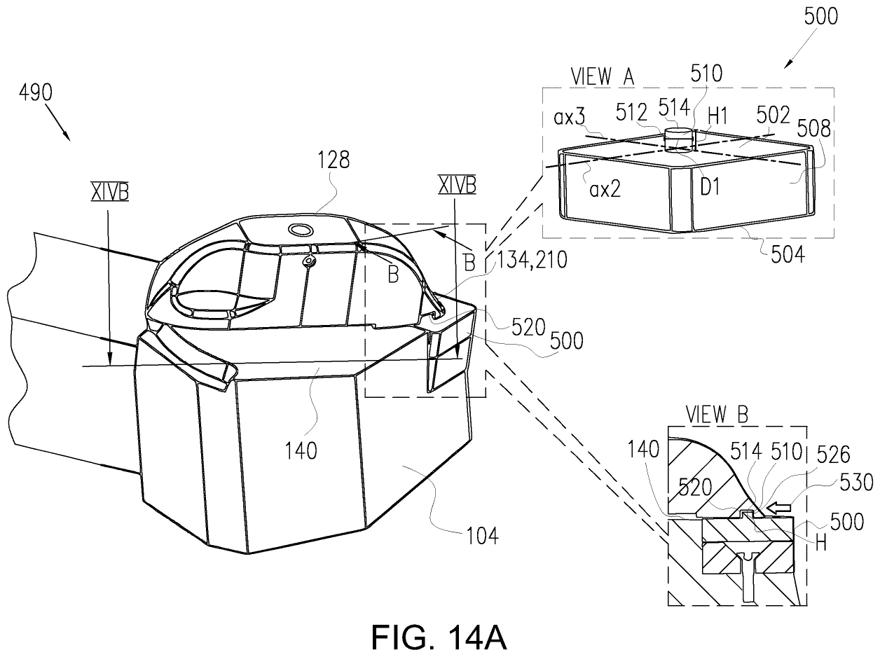

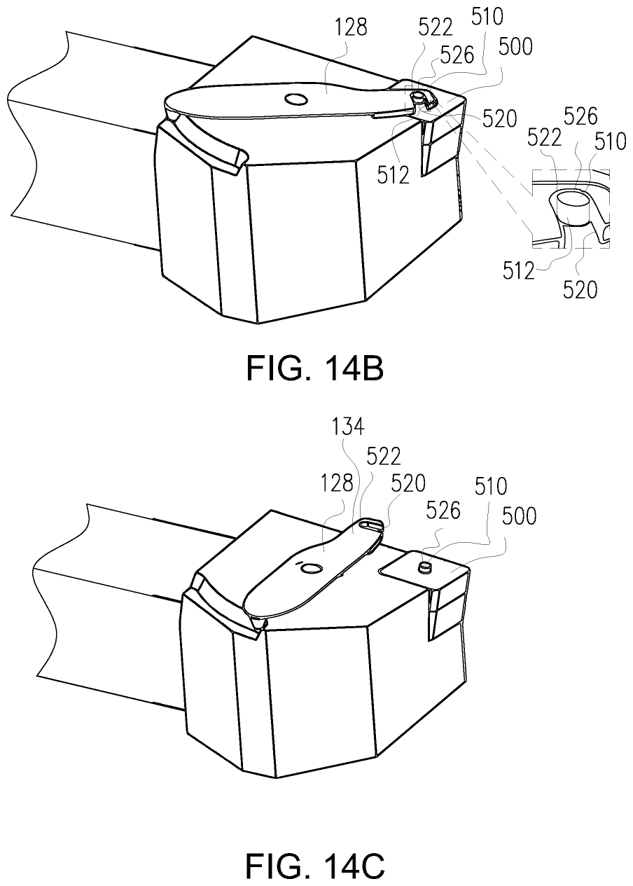

In general, the cutting insert-engaging portion 134 of the clamp 128 is sized for contacting a portion of the cutting insert 124. In the shown example, the cutting insert-engaging portion 134 comprises a projection 210. The projection 210 extends downwardly towards the body 104 from the clamp 128 and is shaped to apply the clamping force 154 on the cutting insert 124. In the example of FIGS. 5-8B, the underside surface 136 of the projection 210 is generally planar. In some embodiments, the projection 210 may be shaped with recesses adapted for grasping the cutting insert 124, as will be further described hereinbelow with reference to FIGS. 14A-15C and 18A to 18C.

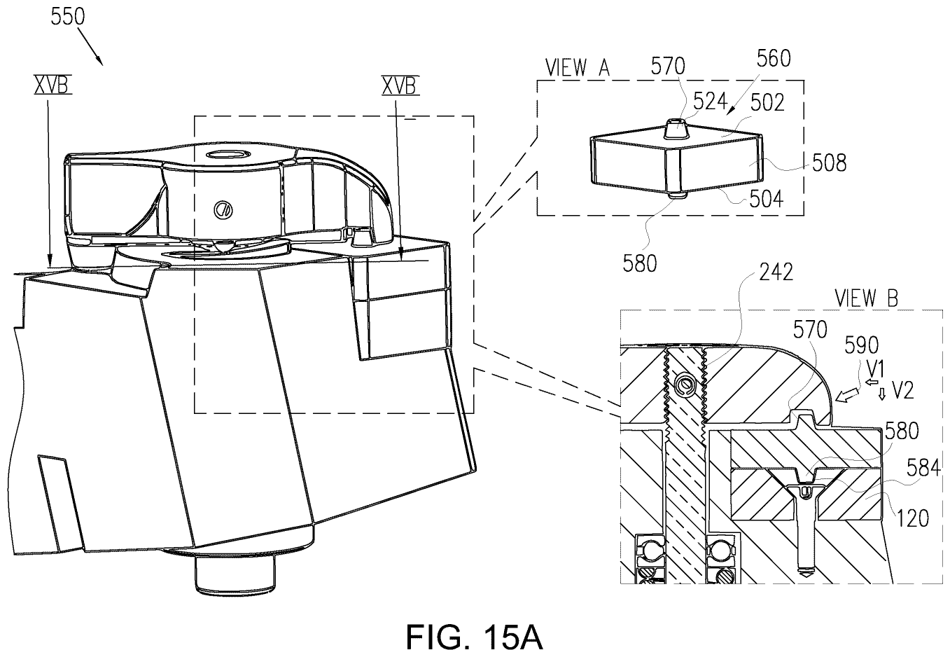

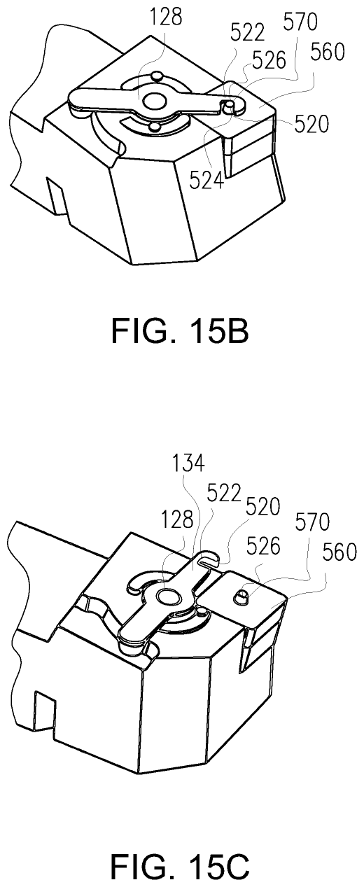

Generally, the clamp 128 is rotatably engaged with the body 104 via the elongated element 132 (FIG. 2) of the rotation unit 130. In the shown example, the elongated element 132 comprises an axle 224 formed with a bolt portion 226 and an enlarged head 228 formed at a lower end 230 of the axle 224. A laterally throughgoing bore 234 is defined at an upper end 236 of the axle 224 and is sized to house a fastening element 240 (e.g. a screw or a bolt) used for fastening the axle 224 to the clamp 128 within the clamp bore 140. The lower end 230 of axle 224 is positioned in the body cavity 146. In some embodiments, the axle 224 may be threadedly connected to the clamp 128 by a threaded connection 242, such as shown for example in FIG. 15A.

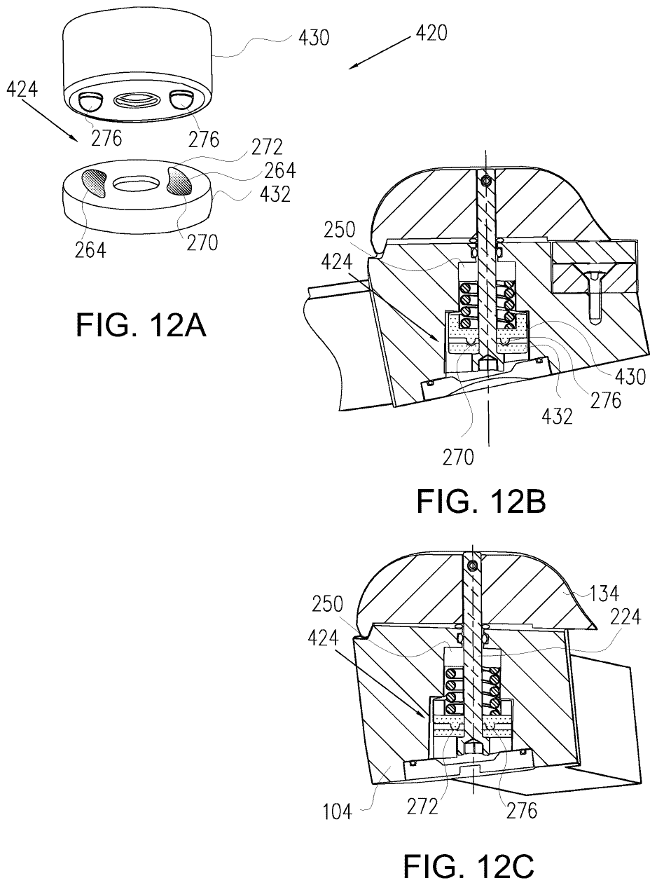

In general, the rotation unit 130 comprises a low friction member for mitigating friction resulting from the compression force 154 applied on the clamp 128 and/or body 104 by the compression unit 150. For a non-limiting example, the low friction member comprises a ball-bearing 248, a static bearing surface, a rotatable bearing, a gear, a belt, and/or a washer (e.g. washer 250 shown in FIGS. 12A and 12B).

In some embodiments, the aforementioned friction can be mitigated by a torque enhancing element (e.g. a spring) or any other suitable (optionally toolless) element designated to increase the rotational motion 180.

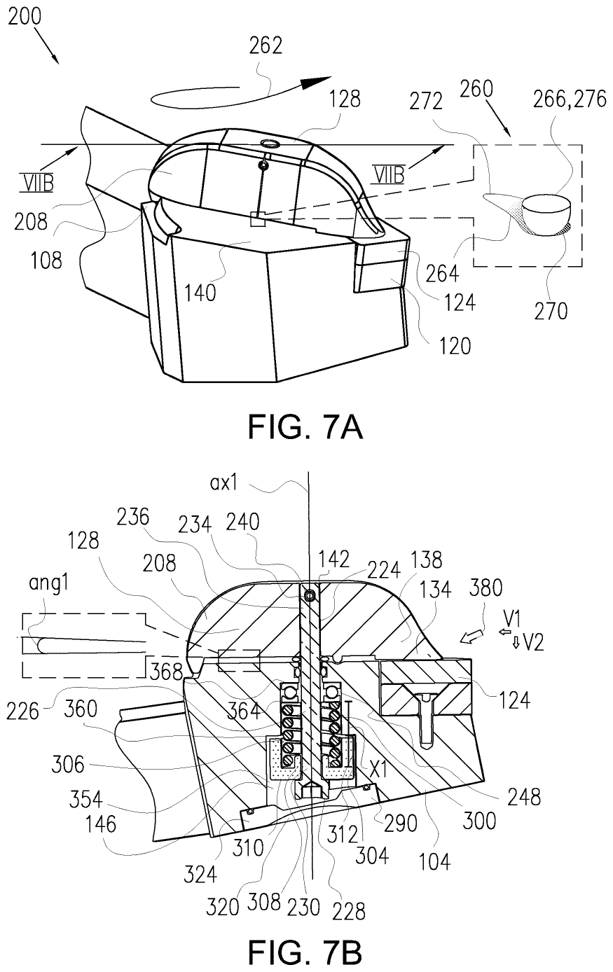

As described hereinabove in reference to FIGS. 1-4B, the clamp 128 is operative to rotate in the rotational motion 180. Cutting tool holder system 200 comprises an elevation arrangement 260 (FIG. 7A) configured to elevate the clamp 128 while rotating the clamp 128. Accordingly, the clamp 128 is rotated in a helical motion 262.

It is to be understood herein that, the term ‘elevation’ is intended to include within the scope thereof even a minimal increase in distance between the underside surface of the clamp (for example, at the cutting insert engaging portion) and the clamp facing surface and/or the cutting insert. The elevation arrangement is intended to signify that in the examples including the elevation arrangement, the rotation of the clamp between the clamping and unclamping positions is movement along a helical path and not a circular path.

In general, the elevation arrangement 260 comprises at least an aligned pair of two axially oppositely-facing surfaces. The first surface is an inclined surface 264 structured with a curvilinear slope. The arch of the slope of the inclined surface 264 in the shown example is substantially circular so as to correspond with the rotational motion 180. In some examples, the arch of the slope of the inclined surface 264 can have a different curvature (rotational or not) about the axis of rotation of the clamp so as not to correspond with the rotational motion 180 as described further herein below. The incline of the slope is configured to increasingly rise codirectionally with the rotational motion 180 when the clamp 128 is maneuvered from the clamping position to the unclamping position and in a direction extending from the body 104 to the clamp 128. Accordingly, the inclined surface 264 constitutes a recess formed in the clamp-facing surface 140, or in underside facing surface 136 of the clamp 128, or in some examples (described further herein below), in a top surface of the cutting insert. The second surface is a vertically adjacent surface 266 with respect to the inclined surface 264 (e.g. vertically adjacent surface 266 is positioned axially above the inclined surface 264 along the longitudinal axis ax1). The vertically adjacent surface 266 is configured to be contiguous with the inclined surface 264 so it can advance on the inclined surface 264, thereby elevating the clamp 128 during the rotational motion 180, thus performing the helical rotation 262 of the clamp 128.

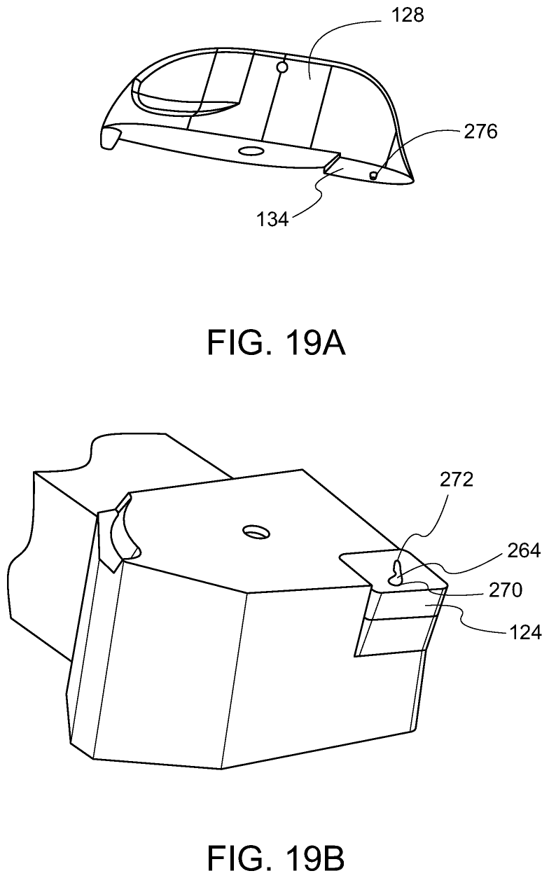

In general, the elevation arrangement 260 can be defined at any suitable location in the cutting tool holder system 200, e.g. the inclined surface 264 may be defined on the clamp 128 or at the cutting tool holder 104 and the vertically adjacent surface 266 may be defined at the oppositely positioned cutting tool holder 104 or clamp 128. In some examples (for example, as described further below with respect to FIGS. 19A and 19B), the inclined surface may be defined on the cutting insert.

It is to be understood herein that the inclined surface (in all the embodiments described herein having the inclined surface(s)) has a slope that rises in a direction extending from the body 104 to the clamp 128 (extending vertically upwards during use of the cutting tool parallel to the longitudinal axis) and codirectionally with the rotational motion 180 in a direction in which the clamp is rotated to displace from the clamping position to the unclamping position (anticlockwise in the illustrated examples). For instance, in the examples where the inclined surface is formed in the body 104 of the cutting tool holder or in the insert, the inclined surface is sloped from a deeper region (deeper into the surface as compared to a superficial region) towards a superficial region in a direction in which the clamp is rotated to displace from the clamping position to the unclamping position (anticlockwise in the illustrated examples). In the examples where the inclined surface is formed in the underside surface 136 of the clamp 128, the inclined surface is sloped from a superficial region to a deeper region (deeper into the surface as compared to the superficial region) in a direction in which the clamp is rotated to displace from the clamping position to the unclamping position (anticlockwise in the illustrated examples). The inclined surface is curved about an axis perpendicular to the surface in which the inclined surface is formed, and has a slope as described herein, therefore, the inclined surface is to be understood as being formed as a portion of a helix whose coils rises from bottom to top in the direction in which the clamp is rotated to displace from the clamping position to the unclamping position (anticlockwise in the illustrated examples).

It is to be further understood herein that the slope of the inclined surface (in all the embodiments described herein having the inclined surface(s)) is inclined at an angle suitable to facilitate movement of the corresponding vertically adjacent surface thereon upon application of a rotational force on the clamp which is of a magnitude compatible with that of a user's manual force. In other words, the slope is predetermined so as to facilitate elevation of the clamp upon application of a rotational force on the clamp which is of a magnitude compatible with that of a user's manual force.

For instance, the slope of the inclined surface is determined to optimize the effective elevation while maintaining the ease of rotation. In some examples, the slope of the inclined surface is determined such that an effective elevation is achieved while not increasing the force required to rotate the clamp beyond a force compatible with that of a user's manual force.

In some examples, the slope of the inclined surface can be at an angle ranging from 15° to 60° with respect to a horizontal plane. In other words, the helix angle of the helical movement of the clamp can range from 15° to 60°. The rotational force required for rotating the clamp from the clamping position to the unclamping position can be less than or equal to a rotational force equivalent to 10 kilogram lifting force.

It is to be further understood herein that the inclined surface (in all the embodiments described herein having the inclined surface(s)) also operates as a guiding surface for maintaining the corresponding protrusion within the deeper region while not allowing the protrusion to fall out of the inclined surface due to inadvertent movement of the cutting insert and the clamp during operation of the cutting insert. For instance, in the clamping mode, when the protrusions tends to move out of the inclined surface (or the inclined surface tends to move with respect to the protrusion) due to inadvertent movement of the cutting insert, the slope of inclined surface brings the protrusion (or the inclined surface) back to the intended position of the protrusion at the deeper region. Therefore, due to the slope of the inclined surface, a minimum force is required to move the protrusion and the inclined surface with respect to each other.

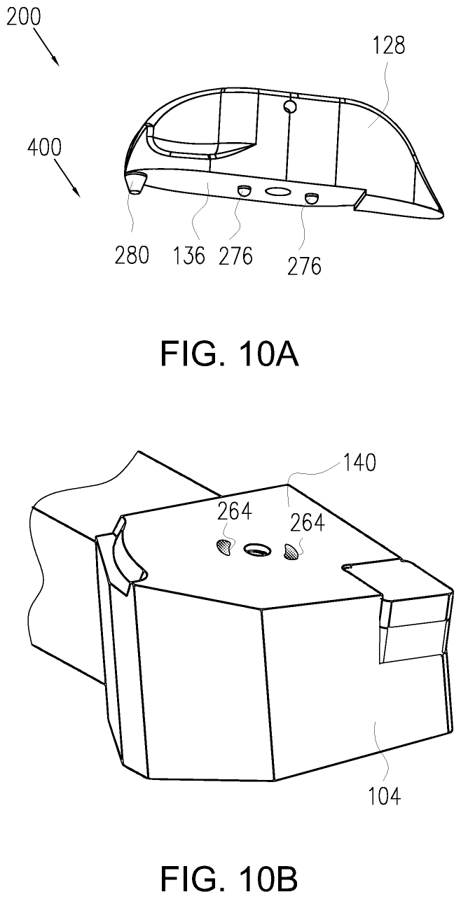

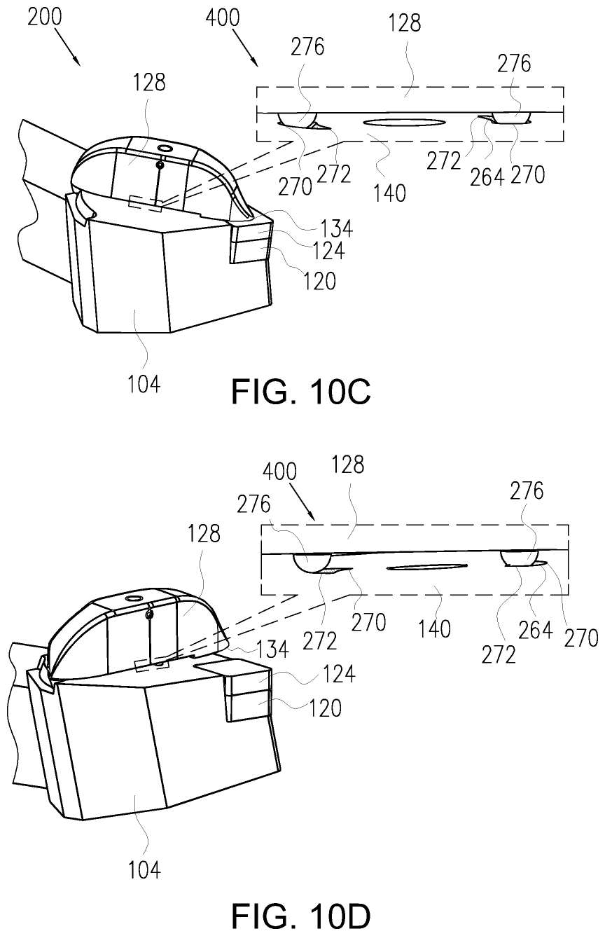

In the shown example of FIGS. 5-8B, a single inclined surface 264 is carved in the clamp-facing surface 140 and is formed with a deeper region 270 (7A and 8A). The deeper region 270 curvilinearly slopes upwardly towards a superficial region 272 codirectionally with the orientation of the rotational motion 180. The vertically adjacent surface 266 comprises at least one protrusion 276 protruding from underside surface 136 of the clamp 128 towards the inclined surface 264. In general, the protrusion 276 is configured with a surface operative to slidably advance along the inclined surface 264. In the shown example, the protrusion 276 is formed as a hemisphere or may comprise any rounded (or any other shape) surface. Further examples of the elevation arrangement 260 and its location will be further described in detail in reference to FIGS. 10A-13B and 19A and 19B.

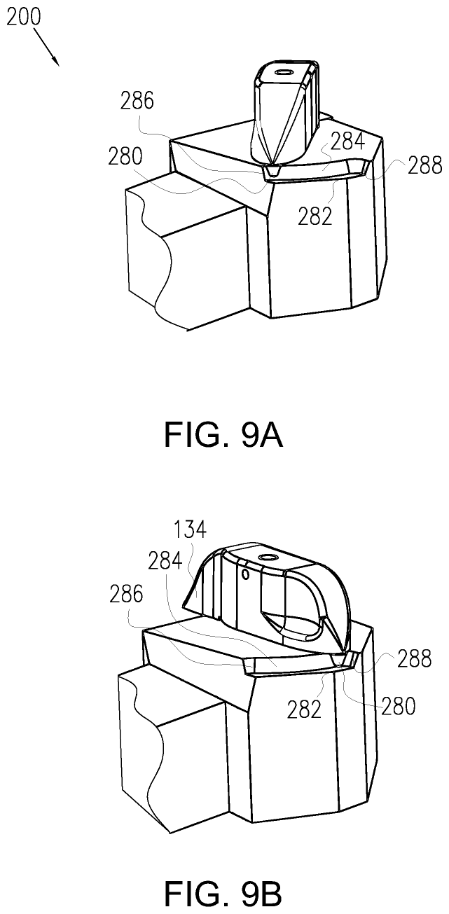

In some examples, the clamp 128 is formed at the clamp rear section 208 with a downwardly facing extension 280 and is configured to slidably move along the body rear section 108 during the rotatable motion 180 and/or the helical motion 262. In the shown example, the body-rear section 108 is formed with a groove 282 surrounded by a wall 284. Wall 284 is bound at its first side by a first adjacent wall, serving as a first wall barrier 286 and is bound at its second side by a second adjacent wall, serving as a second wall barrier 288. The wall 284 is configured for the slidable movement of the extension 280 thereon during the rotatable motion 180 and/or helical motion 262, as will be further described in reference to FIGS. 9A and 9B.

In general, at least one sealant is provided to be disposed within the system 200 for preventing ingress of workpiece residues and/or cooling fluids into the cutting tool holder 102 and/or clamp 128. In a non-limiting example, the sealant may comprise an O-ring, a gasket and/or an adhesive.

In the shown example, the sealant comprises a first sealing ring 290 sized to be disposed within the body 104 intermediate the ball bearing 248 and the clamp-facing surface 140, as well as a second sealing ring 294 sized to be disposed within the body 104 intermediate the body 104 and the clamp 128. Optionally, further sealants may be disposed within the cutting tool holder 102 and/or clamp 128.

The compression unit 150 comprises any means for compression, such as in a non-limiting example: a piston, mechanical fastener, ratchet mechanisms and/or a spring element 300, e.g. a leaf spring, a coil spring and/or a helical spring.

In general, the spring element 300 is disposed at any location within the body 104. In the shown example, the spring element 300 is mounted on a spring support 304 (namely, a supporting member) dimensioned to support the spring element 300. In the shown example, the spring support 304 comprises a central aperture 306 circumscribed by an inner, lateral wall 308 connected via an annular base 310 (FIG. 7B) to an outer, lateral wall 312.

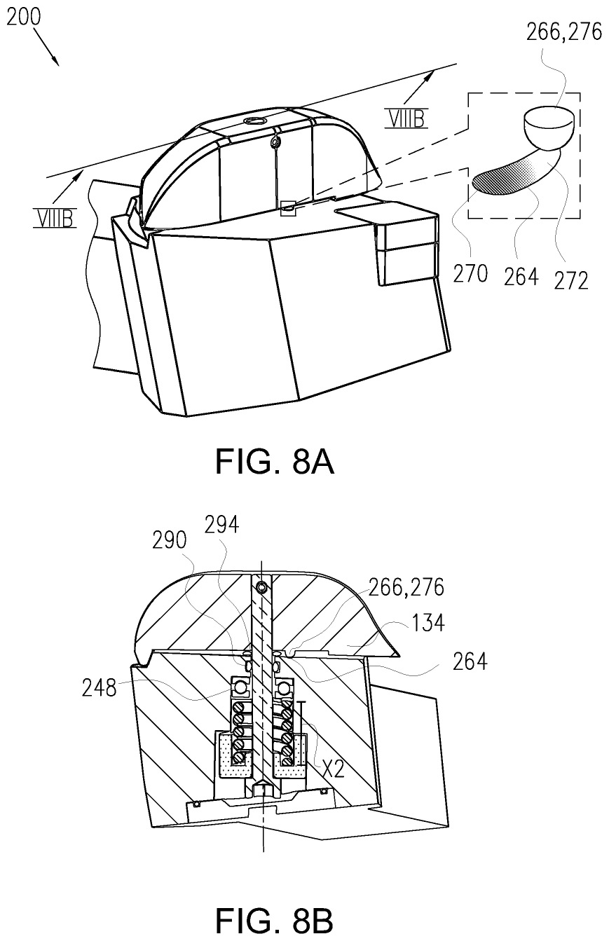

In general, the body 104 is formed with an aperture 320 formed at bottom surface 158 of the body 104 which leads to the base cavity 146 for assembly of at least the rotational unit 130 and the compression unit 150 therein, as will be further described in detail in reference to FIGS. 7A-8B. During operation, the aperture 320 is sealed by a tightly-engaged, removable cover 324.

Reference is made to FIGS. 7A-8B, which are a perspective view and a sectional view of the cutting tool holder system 200 of FIG. 5 shown in a clamped operational mode (FIGS. 7A&7B) and an unclamped operational mode (FIGS. 8A&8B), respectively, and are shown with the cutting insert 124 mounted on the seat 120.

In general, assembly of the cutting tool holder system 200 is performed by positioning the axle 224 within the clamp bore 142 and fastening it at its upper end 236 to the clamp 128 by inserting the fastening element 240 in the throughgoing bore 234. The lower end 230 of the bolt portion 226 of the axle 224 is seated in the central aperture 306 of the spring support 304 and the head portion 228 abuts against an underside of the support base 310. The spring element 300 is disposed within in the support base 310 circumscribing the bolt portion 226. In the shown example, the bearing 248 is disposed above the spring element 300 circumscribing the bolt portion 226, it being appreciated that the location of the spring element 300 and the bearing 248 may reversed, and furthermore, the bearing 248 may be disposed at any other suitable location.

In general, as described hereinabove, the spring element 300 is assembled to be confined intermediate the first barrier 164 and the second barrier 166 (FIG. 3B) for maintaining the spring element 300 under compression through both the clamping and unclamping modes. In the shown example, the aperture 320 of body 104 extends through a wide portion 354 of the body cavity 146 to a peripheral first shoulder 360. The wide portion 354 recedes to a narrow portion 364 of the body cavity 146 to a peripheral second shoulder 368. During assembly, fastening the axle 224 to the clamp 128 via the fastening element 240, urges the head 228 of the axle 224 to press upon the support base 310. The support 304 at its outer, lateral wall 312 is restricted by the first shoulder 360. As described hereinabove, the spring element 300 is mounted on the support base 310. The bearing 248 is disposed upon the spring element 300 and is restricted by the second shoulder 368. Accordingly, the spring element 300 is compressed between the support base 310, which serves as the first barrier 164, and the second shoulder 368, which serves as the second barrier 166. Similar to the description hereinabove in reference to FIG. 3B, during the clamping mode, the spring element 300 is compressed to the first extent, e.g. measured by the first length X1, as shown in FIG. 7B.

In general, due to the elevation arrangement 260, during the clamping mode the clamp 128 is positioned at an incline, i.e. at an angular displacement designated by an angle ang1 in FIG. 7B. Therefore, the clamp rear section 208 is elevated above the body rear section 108 forming a gap therebetween. The gap decreases towards the clamp front section 138 and thus the cutting insert-engaging portion 134 is contiguous with the cutting insert 124. Accordingly, a clamping force (illustrated by arrow 380 in FIG. 7B) exerted by the cutting insert-engaging portion 134 upon the cutting insert 124, is inclined as well, comprising a horizontal component V1 and a vertical component V2. It is thus recognized that whereupon the magnitude of the clamping force 174 is the same as the clamping force 380, the vertical component V2 of the clamping force 380 is less than the vertical component of clamping force 174 (which is substantially identical to the magnitude of the clamping force 174 itself). Accordingly, overcoming the clamping force 380 for maneuvering from the clamping position to the unclamping position in the cutting tool holder system 200 requires a smaller magnitude of rotational force than the rotational force, which is required for overcoming the clamping force 174 (which comprises a vertical component V2 only) in the cutting tool holder system 100.

In general, maneuvering the clamp 128 from the clamping position to the unclamping position is performed by rotating the clamp 128 in the rotation motion 180 (FIG. 3A). As described, due to the elevation arrangement 260, the clamp 128 increasingly rises codirectionally with the rotational motion 180 when the clamp 128 is maneuvered from the clamping position to the unclamping position. Accordingly, the clamp 128 is axially (e.g. vertically) elevated along longitudinal axis ax1 in addition to the rotational motion 180, thereby resulting the helical motion 262.

As described hereinabove in reference to FIGS. 1-4B, the rotational motion 180 can be performed even without a tool, by application of the user's manual force. It is appreciated that in some embodiments, in the cutting tool holder system 200 maneuvering the clamp 128 in the helical motion 262 facilitates use of a manually compatible force of an even smaller magnitude than that required for maneuvering the clamp 128 solely by the rotational motion 180.

Furthermore, it is contemplated that the clamp rear section 208 is elevated above the body rear section 108, thereby preventing friction that would have otherwise occurred during rotation of the clamp rear section 208 while it is contiguous with the body rear section 108.

With attention drawn to the shown example, it is seen that the helical motion 262 is facilitated by advancing the protrusion 276 along the inclined surface 264 while rotating the clamp 128. During the clamping mode shown in FIGS. 7A-B, the protrusion 276 is initially subterraneanly positioned within the deeper region 270 of the inclined surface 264 and as seen in FIG. 7A, the protrusion 276 is sunken in the deeper region 270.

Rotation of the clamp 128 from the clamping position to the unclamping position causes the protrusion 276 to slidably advance along the inclined surface 264 towards the superficial region 272. As seen in FIGS. 8A-B, the protrusion 276 is thus elevated, which in turn elevates the insert-engaging portion 134 as the insert-engaging portion 134 rotates away from the insert 124. The insert-engaging portion 134 disengages, at least partially, from the cutting insert 124 to a degree sufficient for enabling the removal of the cutting insert 124 from the seat 120, for any of indexing, resharpening or replacement thereof.

As described hereinabove, the spring element 300 is compressed to the first extent measured by the first length of X1 during the clamping mode. In general, while rotating the clamp 128 in the helical motion 262, the elevation of the insert-engaging portion 134 raises the rotation unit 130. Accordingly, the compression unit 150 is compressed to a greater second extent and is measured by the second length X2 (FIG. 8B), which is smaller than the first length X1.

In the shown example, the axle 224 is fastened to the clamp 128 by the fastening element 240. During rotation of the clamp 128 from the clamping position to the unclamping position, the insert-engaging portion 134 of the clamp 128 is elevated, raising the axle 224 therewith. Axle head 228, abutting spring support 304, pushes the spring support 304 upwardly, compressing the spring element 300 to the second length X2. In the exemplary cutting tool holder system 200, the compression length X2 is shown to be smaller than the compression length X1, indicating that the compression force upon the compression unit 150 during the unclamping mode (FIGS. 8A-B) is increased with respect to the clamping mode (FIGS. 7A-B).

In some examples, the curvature of the inclined surface 264 about the axis of rotation of the clamp 128 can be different than the curvature of the rotational motion of the clamp 128, thereby causing the clamp 128 to move (at least tend to move) in a direction extending between the clamp rear section 208 and the clamp front section 138 during the rotational motion 180 of the clamp. For instance, the curvature of the inclined surface (whether the inclined surface is positioned on the clamp or on the cutting tool holder) can be configured to cause the clamp to tend to move (if not move) in a direction extending from the seat towards the body rear section of the body during rotation of the clamp from the unclamping position to the clamping position. It is to be understood herein that the curvature of the inclined surface being different from the curvature of the rotation of the clamp is intended to signify that the curvature of the inclined surface defines a path for the corresponding protrusion so to cause the clamp to at least tend to move in a direction extending from the seat towards the body rear section of the body during rotation of the clamp from the unclamping position to the clamping position.

It is to be understood herein that for the purposes of the present description, the phrase ‘tend to move’ is intended to signify that a force exerted on the clamp in the direction extending from the seat towards the body rear section of the body. The force exerted on the clamp causes the clamp to exert that force on the cutting insert in the same direction thereby tightening the clamping of the cutting insert in the direction of the force.

Therefore, according to some examples, the elevation arrangement can operate as a backward force applying mechanism that applies a backward (in the direction extending from the seat towards the body rear section of the body) force on the clamp, thereby causing the clamp to apply the backward force on the cutting insert.

In the examples in which the inclined surface 264 is positioned at the underside surface of the clamp 128 and between the axis of rotation of the clamp and a front end (towards the seat) of the clamp, the superficial region (or the region at which protrusion is located during unclamping mode) of the inclined surface 264 can be closer to the axis of rotation than the deeper region (or the region at which protrusion is located during clamping mode) of the inclined surface 264, and in the examples in which the inclined surface 264 is positioned at the underside surface of the clamp 128 and between the axis of rotation of the clamp and a rear end (opposite the front end) of the clamp, the superficial region (or the region at which protrusion is located during unclamping mode) of the inclined surface 264 can be farther from the axis of rotation than the deeper region (or the region at which protrusion is located during clamping mode) of the inclined surface 264.

Further, in the examples in which the inclined surface 264 is positioned at the cutting tool holder (clamp facing surface) between the axis of rotation of the clamp and a front end (towards the seat) of the clamp facing surface or at the cutting insert, the superficial region (or the region at which protrusion is located during unclamping mode) of the inclined surface 264 can be farther from the axis of rotation than the deeper region (or the region at which protrusion is located during clamping mode) of the inclined surface 264, and in the examples in which the inclined surface 264 is positioned at the cutting tool holder (clamp facing surface) between the axis of rotation of the clamp and a rear end (opposite to front end) of the clamp facing surface, the superficial region (or the region at which protrusion is located during unclamping mode) of the inclined surface 264 can be closer to the axis of rotation than the deeper region (or the region at which protrusion is located during clamping mode) of the inclined surface 264.

Accordingly, in all the above-mentioned orientations of the inclined surface, the rotational movement from the unclamping mode to the clamping mode causes the clamp to move (at least tend to move) backwards in the direction extending from the clamp front section 138 to the clamp rear section 208, thereby applying a clamping force on the cutting insert in the direction extending from the clamp front section 138 to the clamp rear section 208, i.e., adding to the horizontal component V1 of the clamping force.

It is thus recognized that whereupon according to the above-described examples, only the horizontal component V1 of the clamping increases, thereby not increasing the rotational force required for overcoming the clamping force for maneuvering from the clamping position to the unclamping position in the cutting tool holder system, while simultaneously increasing the total clamping force that keeps the cutting insert in place.

It is to be understood herein that the above description with respect to adding to (or increasing) horizontal component V1 of the clamping force, applies to all the examples of the elevation arrangements described herein.

Reference is made to FIGS. 9A and 9B, which are perspective rear views of the cutting tool holder system 200 of FIG. 5 shown in a clamped operational mode (FIG. 9A) and an unclamped operational mode (FIG. 9B). As seen in FIG. 9A, during the clamping mode the extension 280 is positioned proximally to the first wall barrier 286. During the rotational motion 180 and/or the helical motion 262 of the clamp 128, the extension 280 slidably advances along wall 284 within groove 282. During the unclamping mode, further rotation of the extension 280 is blocked by the second barrier 288. Accordingly, the cutting insert-engaging portion 134 is limited to rotate from above the cutting insert 124 (in the clamping mode) to above the clamp-facing surface 140 that is substantially adjacent to the cutting insert 124 (in the unclamping mode). In some examples, the groove may not include the first and second barriers.

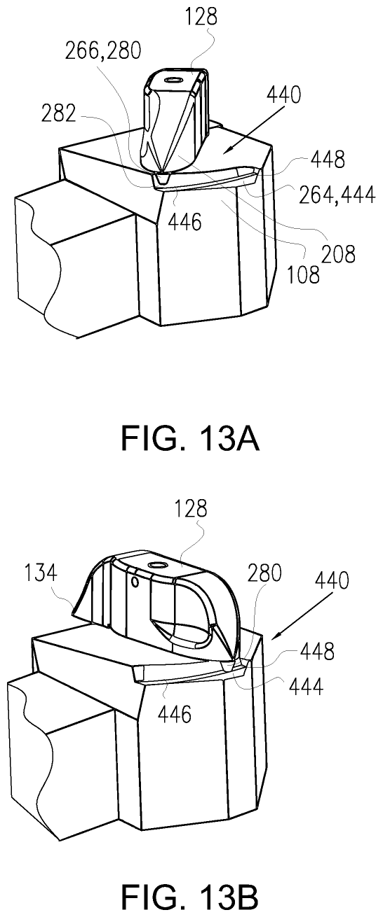

It is to be understood herein that in some examples, the groove or recess 282 and the extension 280 can be manufactured and configured to operate for adding to (or increase) the horizontal component V1 of the clamping force in the same manner as described above for the inclined surface and the protrusion (the elevation arrangement), thereby being configured to operate as the backward force applying mechanism that applies a backward (in the direction extending from the seat towards the body rear section of the body) force on the clamp, thereby causing the clamp to apply the backward force on the cutting insert. For instance, the cutting holder system according to any of the examples described herein can include (with or without the elevation arrangement), the arrangement of the groove (or recess) 282 and the extension 280 (whether constituting an elevation arrangement (described with respect to FIGS. 13A and 13B) or not constituting an elevation arrangement (described with respect to FIGS. 9A and 9B)) for the purpose of adding to (or increasing) the horizontal component V1 of the clamping force in the same manner as described above for the inclined surface and the protrusion arrangement, whereas the groove serves the purpose of the inclined surface (while being inclined (i.e., constituting the elevation arrangement as well) or not constituting the elevation arrangement) and the extension serves the purpose of the protrusion. It is to be understood herein that for the purpose of adding to (or increasing) the horizontal component V1 of the clamping force, the groove 282 and extension 280 can be positioned at any location along the clamp and the body other that the respective rear sections 208 and 108.

For instance, in the example illustrated in FIGS. 9A and 9B, the curvature of the wall 284 can be different from the curvature of the rotational movement of the clamp. The portion of the wall 284 at which the extension 280 is positioned (and abuts the wall 284) at the clamping mode (FIG. 9A) can be farther from the rotational axis as compared to the portion of the wall 284 at which the extension is positioned (and abuts the wall 284) at the unclamping mode (FIG. 9B). Thus, when the clamp is rotated from the unclamping mode to the clamping mode, the extension 280 moves along the wall 284 (while abutting the wall 284) while being simultaneously moved in the direction extending from the clamp front section 138 to the clamp rear section 208, thereby causing the clamp 128 (on which the extension 280 is formed in the illustrated example) to at least tend to move backwards in the direction extending from the clamp front section 138 to the clamp rear section 208, thereby exerting a clamping force on the cutting insert in the direction extending from the clamp front section 138 to the clamp rear section 208, i.e., adding to the horizontal component V1 of the clamping force.

In some examples, the backward force applying mechanism can be realized by a protrusion (for example, extension 280) protruding from the clamp rear section, the wall 284 can constitute the rear wall of the body of the cutting tool holder without the groove 282. In some examples, the wall 284 can be formed as a tapered surface instead of being formed as a vertical wall.

It is accordingly to be understood herein that in all the examples of the cutting tool holder system described herein, the purpose of elevation arrangement and the purpose of increasing the horizontal component of the clamping force can be achieved by a single arrangement (the elevation arrangement) or distinct arrangements. Further, in all the examples of the cutting tool holder system described herein without the elevation arrangement, the arrangement for the purpose of increasing the horizontal component of the clamping force can be realized in the form of a groove or recess and a protrusion or extension.

It is to be understood herein that in some examples, the groove 282 and the extension 280 can switch positions, i.e., the groove 282 can be positioned at the clamp and the extension 280 can be positioned at the body of the cutting tool holder, while serving some or all of the purposes thereof as described above.

Reference is made to FIGS. 10A-13B, which are alternative elevation arrangements 260 or additional elevation arrangements to the exemplary elevation arrangement 260 shown in FIGS. 7A-8B.

Reference is made to FIGS. 10A-D, which are a perspective view of the clamp 128 at an underside thereof (10A), a perspective view of the body 104 (10B), the cutting tool holder system 200 at a clamped operational mode (FIG. 10C) and at an unclamped operational mode (FIG. 10D).

As seen in FIGS. 10A and 10B, an elevation arrangement 400 comprises two (or more) pairs, in which each of the pairs comprises the first surface (e.g. inclined surface 264 shown in FIG. 10A) and second surface (e.g. vertically adjacent surface 266, shown here as the protrusion 276 in FIG. 10A). In the shown example, the inclined surfaces 264 are carved in the body 104 at the clamp-facing surface 140. The two inclined surfaces 264 are generally positioned opposite each other, equidistantly from a common centroid of the inclined surfaces 264. Two corresponding protrusions 276 protruding from the clamp 128 from the underside surface 136 thereof are aligned with the corresponding inclined surfaces 264.

As seen in FIG. 10C, during the clamping mode each of the protrusions 276 are initially subterraneanly positioned within the deeper region 270 of the inclined surface 264.

As seen in FIG. 10D, rotation of the clamp 128 from the clamping position to the unclamping position causes the protrusion 276 to slidably advance along the inclined surface 264 towards the superficial region 272. The protrusions 276 are thus elevated, which in turn elevates the insert-engaging portion 134 as the insert-engaging portion 134 rotates away from the cutting insert 124. The cutting insert 124 is thereby unclamped from the cutting tool holder 102, as described hereinabove.

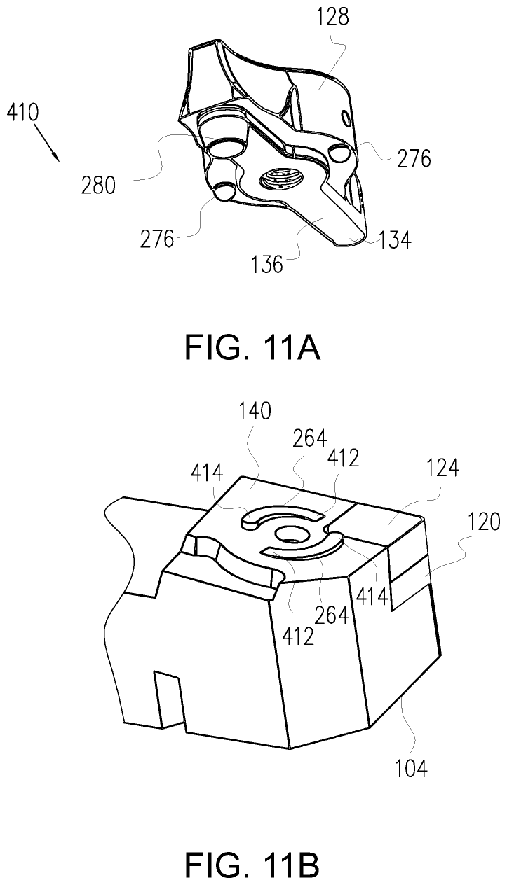

Reference is made to FIGS. 11A and 11B, which are a perspective view of the clamp 128 at an underside surface 136 thereof (11A) and a perspective view of the body 104 (11B).

As seen in FIGS. 11A and 11B, an elevation arrangement 410 comprises two (or more) pairs, in which each of the pairs comprises the first surface (e.g. inclined surface 264 shown in FIG. 11B) and second surface (e.g. vertically adjacent surface 266, shown here as the protrusion 276 in FIG. 11A). In the shown example, the inclined surfaces 264 are structured on the clamp-facing surface 140 emerging therefrom and are generally positioned opposite each other equidistantly from a common centroid of the inclined surfaces 264. Two corresponding protrusions 276 protruding from the clamp 128 from the underside surface 136 thereof are aligned with the corresponding inclined surfaces 264.

In FIGS. 11A and 11B, any one of the inclined surfaces 264 is formed as a ramp with a deeper region 412 that curvilinearly slopes upwardly towards a superficial region 414 codirectionally with the orientation of the rotational motion 180 and/or the helical motion 262.

Similar to the operational modes described in reference to FIGS. 10C and 10D, during the clamping mode each of the protrusions 276 are initially positioned upon the deeper region 412 of the inclined surfaces 264.

Rotation of the clamp 128 from the clamping position to the unclamping position causes the protrusion 276 to slidably advance along the inclined surface 264 towards the superficial region 414. The protrusions 276 are thus elevated, which in turn elevates the insert-engaging portion 134 as the insert-engaging portion 134 rotates away from the cutting insert 124. The cutting insert 124 is thereby unclamped from the cutting tool holder 102, as described hereinabove.

Reference is made to FIGS. 12A-C, which are a perspective view of a spring support 420 comprising an elevation arrangement 424 (12A) and the cutting tool holder system at a clamped operational mode (FIG. 12B) and at an unclamped operational mode (FIG. 12C).

As seen in FIG. 12A, the spring support 424 may be similar to the spring support 304 of FIGS. 1A-11B yet additionally comprises the elevation arrangement 424. In the shown example, the spring support 420 comprises an upper portion 430 and a lower portion 432. Similar to the elevation arrangement 260 of FIGS. 10A-D, two inclined surfaces 264 are carved in the lower portion 432. Each inclined surface 264 is paired and aligned with one of the protrusions 276, which protrude from the upper portion 430.

As seen in FIG. 12B, during the clamping mode each of the protrusions 276 are initially subterraneanly positioned within the deeper region 270 of the corresponding inclined surface 264.

As seen in FIG. 12C, rotation of the clamp 128 from the clamping position to the unclamping position causes the protrusion 276 to slidably advance along the inclined surface 264 towards the superficial region 272. The protrusions 276 are thus elevated, which in turn elevates the upper portion 430 of the spring support 424, thereby elevating the axle 244 and the clamp 128 as the insert-engaging portion 134 rotates away from the cutting insert 124. The cutting insert 124 is thereby unclamped from the cutting tool holder 102, as described hereinabove.

It is noted that in general the elevation arrangement 424 of the spring support 420 may comprise any one of the elevation arrangements described hereinabove.

It is further noted that the elevation arrangement may be formed in any one of the surfaces or components within the cutting tool system holder described herein, such as at the axle 224 and/or within the body 104, for example.

Reference is made to FIGS. 13A and 13B, which are a perspective view of the cutting tool holder system comprising an elevation arrangement 440 at a clamped operational mode (FIG. 13A) and at an unclamped operational mode (FIG. 13B).

In general, the elevation arrangement 440 comprises the first, inclined surface 264 formed as a ramp 444 defined within the groove 282. The second vertically adjacent surface 266 comprises the extension 280 or any other similar configuration. The ramp 444 comprises a deeper region 446 that curvilinearly slopes upwardly towards a superficial region 448 codirectionally with the orientation of the rotational motion 180 and/or the helical motion 262.

As seen in FIG. 13A, during the clamping mode the extension 280 is initially positioned upon the deeper region 446 of the ramp 444.

As seen in FIG. 13B, rotation of the clamp 128 from the clamping position to the unclamping position causes the extension 280 to slidably advance along ramp 444 towards the superficial region 448. The extension 280 is thus elevated, which in turn elevates the insert-engaging portion 134 as the insert-engaging portion 134 rotates away from the cutting insert 124. The cutting insert 124 is thereby unclamped from the cutting tool holder 102, as described hereinabove.

It is noted that the elevation arrangements described in reference to FIGS. 5-12C are shown to be disposed about the longitudinal axis ax1 in proximity to the clamp cavity 142 and the bore cavity 146. It is appreciated that these elevation arrangements may be disposed at any suitable location, such as at the clamp rear section 208 and the body rear section 108, as shown in FIGS. 13A and 13B, or at the cutting-insert engaging portion and the cutting insert, as shown in FIGS. 19A-19B and described herein further below. Further, the inclined surface and the protrusion can interchange positions, for examples, the inclined surface can be positioned at the clamp and the protrusion can be formed on the cutting tool holder or the cutting insert. In the examples with more than one pairs of inclined surface and protrusion, one or more of the pairs can interchange positions, for examples, one or more of the inclined surfaces can be positioned on the clamp while one or mor of the inclined surfaces can be positioned on the cutting tool holder with oppositely positioned protrusions.

It is to be understood herein that in all the examples of the cutting tool holder system described herein without an elevation arrangement and/or with an elevation arrangement other than one constituted by the extension 280 and the groove 282, the arrangement of the extension 280 and the groove 282 (whether shown in the corresponding drawings or not) is optional and the cutting tool holder system can operate without the arrangement of the extension 280 and the groove 282. In other words, in all the examples of the cutting tool holder system described herein except the one described with respect to FIGS. 13A and 13B (where the elevation arrangement is constituted by the extension 280 and the groove 282 and is the only elevation arrangement), the arrangement of the extension 280 and the groove 282 is optional and the cutting tool holder system can operate without the arrangement of the extension 280 and the groove 282.

Reference is made to FIGS. 14A-C, which are a perspective view of a cutting tool holder system 490 (14A) and cross-sectional illustrations taken along lines XIVB-XIVB in FIG. 14A at a clamped operational mode (FIG. 14B) and at an unclamped operational mode (FIG. 14C).

As seen in FIG. 14A at window A, a cutting insert 500 defining a top surface 502 (interchangeably used herein with insert top surface) and a bottom surface 504 at its base 508 is formed with at least one protrusion 510 protruding from top surface 502. A generally central horizontal axis ax2 and an orthogonal generally central lateral axis ax3 are defined at the plane of top surface 502. The top surface 502 faces the clamp 128 (i.e. the top surface 502 is a clamp-interfacing surface). It is to be understood herein that the top surface (interchangeably used herein with insert top surface) of the cutting insert is intended to signify the surface facing the clamp when the cutting insert is positioned in the seat for operation thereof.

In general, the protrusion 510 is arranged at any location on the top surface 502 and is aligned with a recess 520 formed in the cutting insert-engaging portion 134 of clamp 128, namely at an underside of the cutting insert-engaging portion 134.

In some examples, the protrusion 510 is positioned at least at the midpoint (e.g. center) of one of the horizontal axis ax2 and/or lateral axis ax3. In the shown example, the protrusion 510 is positioned at the center of both horizontal axis ax2 and lateral axis ax3.

In general, the protrusion 510 comprises a lateral wall 512 and an upper surface 514 and defines a height H1 and a diameter D1, (window of view A). The height H1 and diameter D1 are dimensioned for allowing the cutting insert-engaging portion 134 to grip and be contiguous with the insert protrusion 510 so as to apply the clamping force (e.g. clamping force 174 of FIG. 3B) onto the cutting insert 500, via the protrusion 510, yet without subjecting the protrusion 510 to load failure caused by the clamping force 174.

In general, the protrusion 510 is designed with its height H1 at least partially (e.g. fully) protruding axially above the clamp-facing surface 140 of the body 104. This facilitates positioning the protrusion 510 within the recess 520 of the cutting insert-engaging portion 134 for allowing its gripping thereby, and for transferring the aforementioned clamping force 174 from the clamp 128 to the base 508 of the insert 500, via the protrusion 510.

While the height H1 and diameter D1 are dimensioned to be sufficiently large to withstand the clamping forces 174, they may be designed to be sufficiently small so as to lower costs and furthermore, to prevent formation of a relatively large gap intermediate the clamp 128 and the clamp-facing surface 140, which may allow inadvertent ingress of workpiece residues therebetween.

In general, the lateral wall 512 is formed with any suitable surface which allows the gripping thereof by the cutting insert-engaging portion 134 at recess 520. In some examples, the lateral wall 512 comprises a rectangular cross section. In some examples, the lateral wall 512 comprises a curved surface such a cylindrical wall, shown in FIG. 14A or a frustum-conical wall 524, shown in FIG. 15A or in a non-limiting example, a conical surface, a spheroid surface etc.

As described, the clamping force is applied to the base 508 of the insert 500 via the protrusion 510.

In some embodiments, the recess 520 or any other surface of the cutting insert-engaging portion 134 may apply the clamping force to the upper surface 514 of the protrusion 510. Accordingly, the transferred clamping force is applied to the base 508 of the insert 500 in parallel with the longitudinal axis ax1 (FIG. 3B).

In the shown examples of FIGS. 14A-14C, the recess 520 is designed with a curved surface 522 formed with a curvature sized to be contiguous with the lateral wall 512 of the protrusion 510 at a contact surface 526 defined on a portion of lateral wall 512. It is noted that minimizing the surface of contact between the cutting insert-engaging portion 134 and the insert 500 (to the curved surface 522 and the corresponding contact surface 526) may be advantageous since the frictional forces applied to the cutting insert-engaging portion 134 are thereby limited. This may result in prolonging the shelf life of the clamp 128 and/or of the insert 500.

Since the contact surface 526, contiguous with the recess curved surface 522, is defined at the lateral wall 512, the transferred clamping force is at least partially applied to the base 508 of the cutting insert 500 in a horizontal orientation which is orthogonal to the longitudinal axis ax1, as shown by arrow 530 in view B of FIG. 14A. The transferred clamping force clamps the insert 500 to the seat 120 during the clamping mode, as shown in FIG. 14B.

As seen in FIG. 14C, rotation of the clamp 128 from the clamping position to the unclamping position distances the curved surface 522 from the contact surface 526 as the insert-engaging portion 134 rotates away from the insert 500. Accordingly, the cutting insert 500 is now unclamped to the cutting tool holder 102, as described hereinabove.

Reference is made to FIGS. 15A-C, which are a perspective view of a cutting tool holder system 550 (15A) and cross-sectional illustrations taken along lines XVB-XVB in FIG. 15A at a clamped operational mode (FIG. 15B) and at an unclamped operational mode (FIG. 15C).

As seen in FIG. 15A at window A, a cutting insert 560 comprises an upper protrusion 570 protruding from the top surface 502 of the cutting insert body 508. The cutting insert 560 is similar to cutting insert 500 of FIGS. 14A-C. However, in the embodiment of cutting tool holder system 550, the cutting insert 560 comprises an additional lower protrusion 580 protruding from the bottom surface 504 of base 508. Additional protrusions may be provided. The lower protrusion 580 may define a height and diameter dimensioned to be seated within an aperture 584 formed in seat 120. It is noted that aperture 584 may be formed in conventional seats.

Furthermore, as mentioned hereinabove, the lateral wall 524 of the upper protrusion 570 comprises a frustum-conical wall. In the shown example, the lateral wall of the lower protrusion 580 comprises a frustum-conical wall as well, yet it may comprise any suitable surface.

In the shown examples of FIGS. 15A-C, the cutting-insert engaging portion 134 is designed with the curved surface 522 of recess 520. The curved surface 522 is formed with a curvature sized to be contiguous with the lateral wall 524 of the protrusion 570 at the contact surface 526 defined thereon.

Since the contact surface 526, contiguous with the recess curved surface 522, is defined at the lateral wall 524, the transferred clamping force is applied to the base 508 of the insert 560 in an orientation shown by arrow 590 in view B of FIG. 15A, normal to the orientation of the lateral wall 524. This applied force 590 comprises the vertical component V2 parallel to longitudinal axis ax1 as well the orthogonal horizontal component V1. As described in reference to FIGS. 5-8B, whereupon the clamping force 590 comprises a horizontal component V1, the vertical component V2 is thereby reduced. Accordingly, overcoming the clamping force 590 for maneuvering from the clamping position to the unclamping position in the cutting tool holder system 550, is facilitated by a smaller magnitude of rotational force than the rotational force, which is required for overcoming a clamping force (e.g. clamping force 174), which comprises a vertical component only.

As seen in FIG. 15B, during the clamping mode the contact surface 526 of the protrusion 570 is contiguous with the corresponding curved surface 522 of the clamp 128 and thereby the insert 560 is in a clamping position.

As seen in FIG. 15C, rotation of the clamp 128 from the clamping position to the unclamping position distances the curved surface 522 from the contact surface 526 as the insert-engaging portion 134 rotates away from the insert 560. Accordingly, the cutting insert 560 is now unclamped to the cutting holder 102, as described hereinabove.

It is noted that the cutting tool holder system 550 is shown to comprise the clamp 128 and cutting tool holder 102 of FIGS. 11A and 11B. This is shown as an exemplary system and may comprise any other suitable clamp and cutting tool holder configuration.

In general, the cutting inserts 500 and 560 are formed of any suitable material, such as a material with a sufficient hardness degree operative to withstand the respective clamping forces 530 and 590.

In general, the protrusion 510 of cutting insert 500 and the protrusions 570 and/or 580 of cutting insert 560 may be formed of the same or different material as the base 508.

In some examples, the protrusion 510 of cutting insert 500 and the protrusions 570 and/or 580 of cutting insert 560 are fabricated with the base 508 to form a monolithic cutting insert 500 and 560, respectively.

It is noted that any one of the cutting tool holder systems 490 and 550 may comprise any one of the components (e.g. the clamp 128 and the cutting tool holder 104) of the cutting tool holder systems 100 and/or 200 or the cutting tool holder systems of FIGS. 1A-13B, matatus mutandis. Similarly, the cutting inserts 500 and 560 may be incorporated within the cutting tool holder systems 100 and/or 200 or the cutting tool holder systems of FIGS. 1A-13B, matatus mutandis.

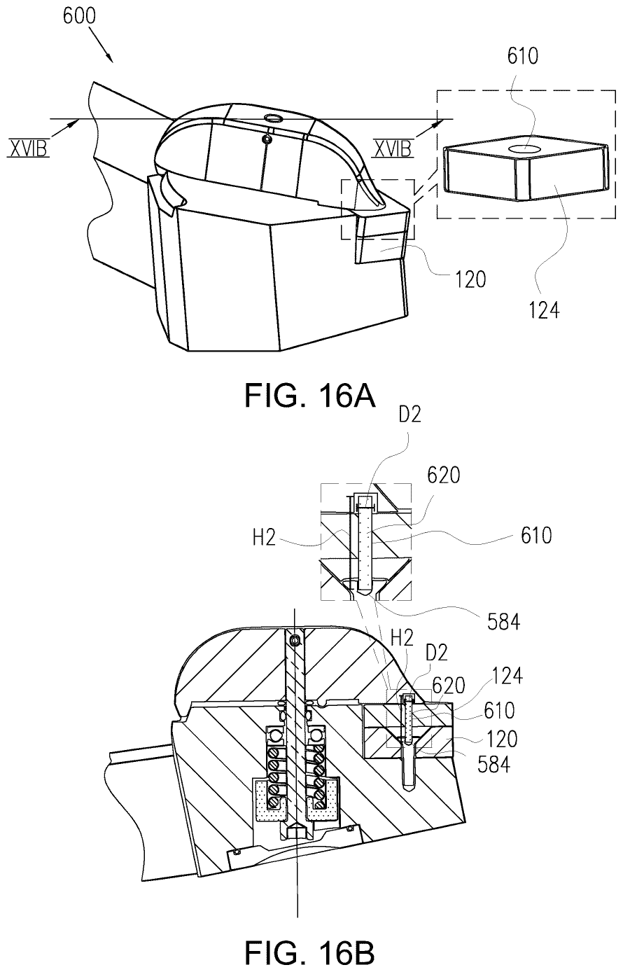

Reference is made to FIGS. 16A and 16B, which are a perspective view of a cutting tool holder system 600 (16A) and a cross-sectional illustration taken along lines XVIB-XVIB in FIG. 16A at a clamped operational mode (FIG. 16B).

As seen in FIG. 16A, the cutting insert 124 may be similar to the cutting inserts of FIGS. 1A-13B and may be formed with an at least partially (e.g. fully) throughgoing central aperture 610. It is noted that aperture 610 may be formed in conventional cutting inserts 124.

As seen in FIG. 16B, the seat 120 is formed with a rod 620. The rod 620 comprises a diameter D2 suitable to be mounted within aperture 584 of seat 120 and aperture 610 of insert 124. The rod 620 comprises a height H2 sufficiently long to extend through aperture 584 of seat 120 and aperture 610 of insert 124 as well as a height which at least partially (e.g. fully) axially protrudes above the clamp-facing surface 140 of the body 104 (similar to the abovementioned height H1 in FIG. 14A).

It is appreciated that the cutting tool holder system 600 provides the benefits of applying a clamping force to a portion (e.g. protrusion 510) above the base 508 of a cutting insert, yet is facilitated for use with conventional cutting inserts 124.

It is to be understood herein that in all of the examples described above with respect to FIGS. 14A-16B, the recess formed in the clamp (for example, recess 520 in FIGS. 14A-15C and the recess formed in the clamp corresponding to the rod 620 in FIGS. 16A-16B) and the corresponding protrusion can additionally constitute an elevation arrangement, whereas the recess can include an inclined surface (the bottom surface of the recess can be inclined) configured to engage a top surface of the corresponding protrusion and operate in the same manner as described herein above for the examples of the elevation arrangement.

Further, it is to be understood herein that in all of the examples described above with respect to FIGS. 14A-16B, the recess formed in the clamp (for example, recess 520 in FIGS. 14A-15C and the recess formed in the clamp corresponding to the rod 620 in FIGS. 16A-16B) and the corresponding protrusion can additionally (or alternatively) constitute an arrangement to increase the horizontal component of the clamping force. For instance, the curvature of the recess formed in the clamp about the axis of rotation can be different from the curvature of the rotational movement of the clamp, in the same manner as described herein above with respect to the arrangements for increasing the horizontal component of the clamping force and operate in the same manner.

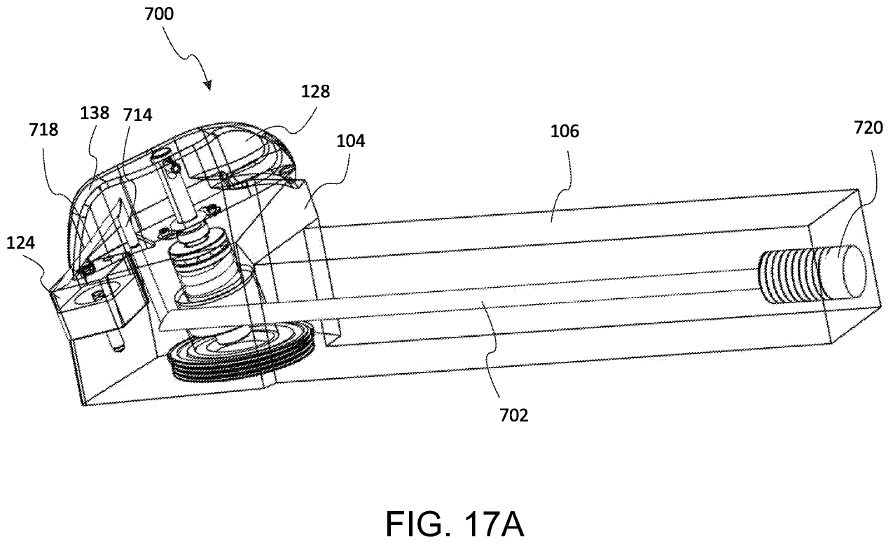

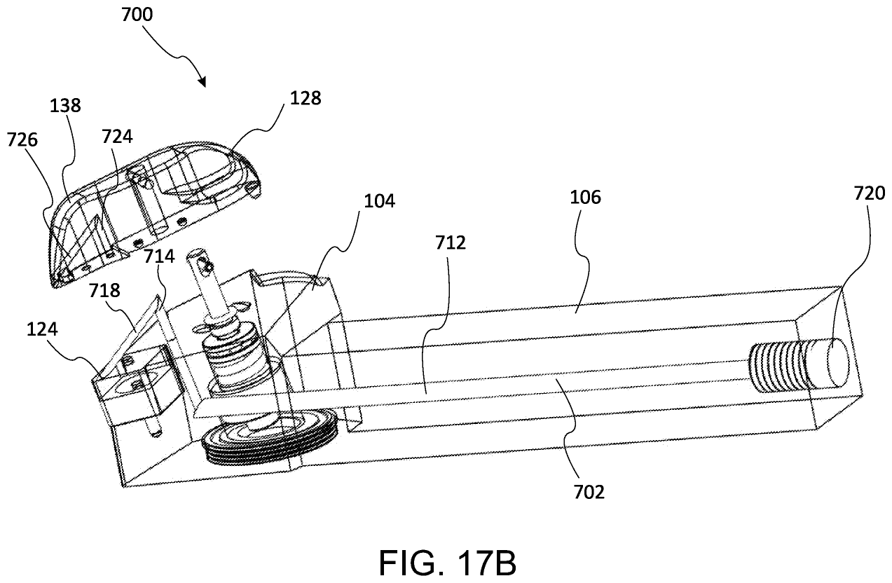

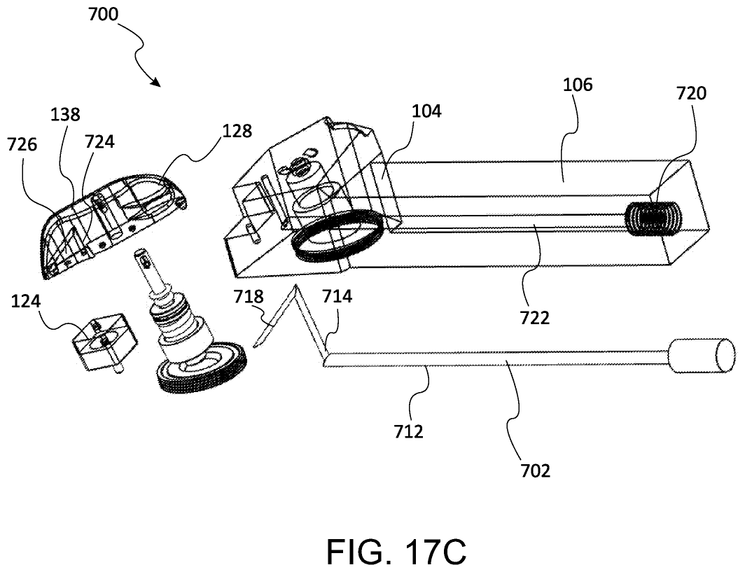

Reference is made to FIGS. 17A-C, which are a perspective view of a cutting tool holder system (17A), a partially exploded view of the cutting tool holder system of FIG. 17A (17B) and further exploded view of the cutting tool holder system shown (17C) at a clamped operational mode, according to an embodiment of the presently disclosed subject matter.

As seen in FIG. 17A a cutting tool holder system 700 may be as described in reference to any one of the cutting tool holder systems of FIGS. 1-16B with the addition of a cooling unit 702. In general, the cooling unit 702 comprises any suitable channel (open or closed), such as a conduit configured for flow of a cooling fluid therethrough from a cooling source to the cutting insert 124. The cooling of the insert 124 is typically performed during the cutting operation of a workpiece. The conduit may be configured in any suitable matter for guiding the cooling fluid to the insert 124.

In general, the channel may be formed within any component of the cutting tool holder system 700, such as within one or more of the shank 106, body 104, clamp 128 and/or insert 124.

In the shown example, the conduit comprises a pipe assembly comprising a first pipe section 712 which is housed at least partially (e.g. fully) within the shank 106. The first pipe section 712 is shown to be threadably engaged within the shank 106 and laterally extend to a second pipe section 714 housed within the body 104. The second pipe section 714 is shown to extent upwards with respect to the longitudinal axis ax1 (FIG. 3B) (parallel or angularly thereto) from the body 104 through the clamp 128. A third pipe section 718 extends from second pipe section 714 at an incline generally within the front section 138 of the clamp 128 commencing above the insert 124 for delivering the coolant at the cutting insert during operation thereof.

As seen in FIGS. 17B and 17C, the cutting tool holder 102 and the clamp 128 are formed with volumes for housing the conduit. In the shown example, the shank 106 is formed with a threaded recess 720 for engaging with the first pipe section 712 and extends to a throughgoing first bore 722. A second bore 724 is formed within body 104 and extends therethrough clamp 128 for housing the second pipe section 714 therein. A third bore 726 is formed within clamp 128 and is dimensioned to house the third pipe section 718 therein. An external coolant source can be connected at the threaded recess 720 for introducing the coolant.

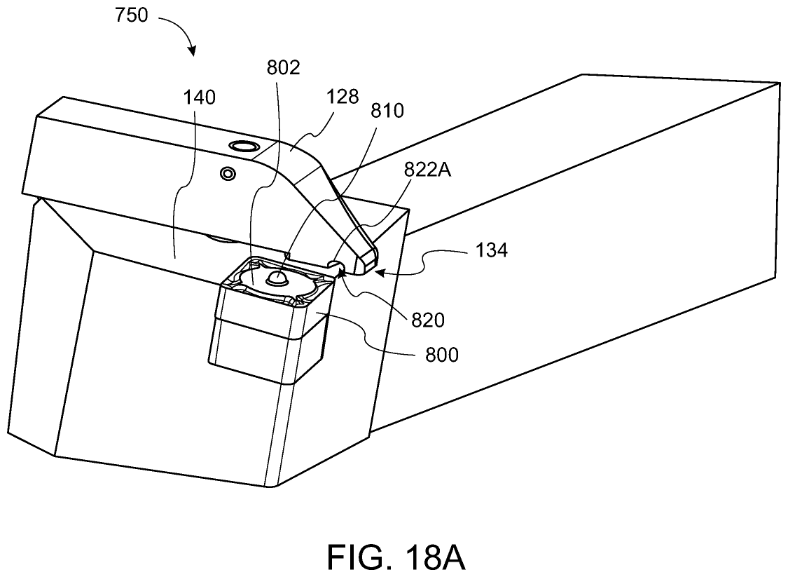

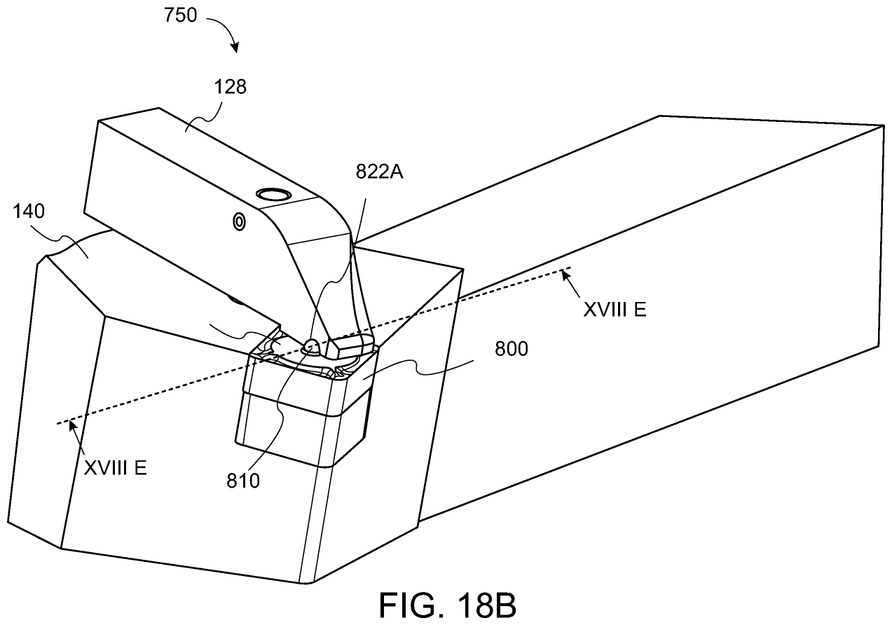

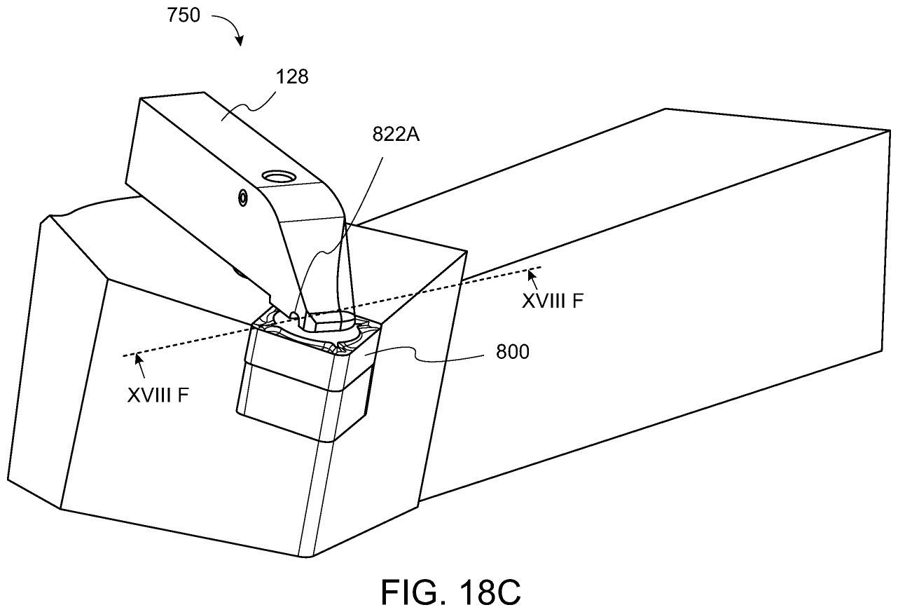

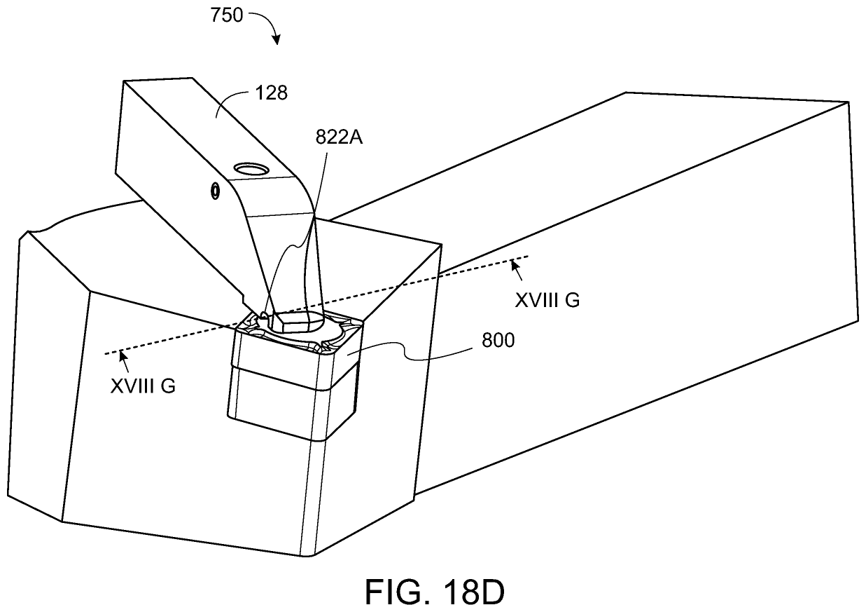

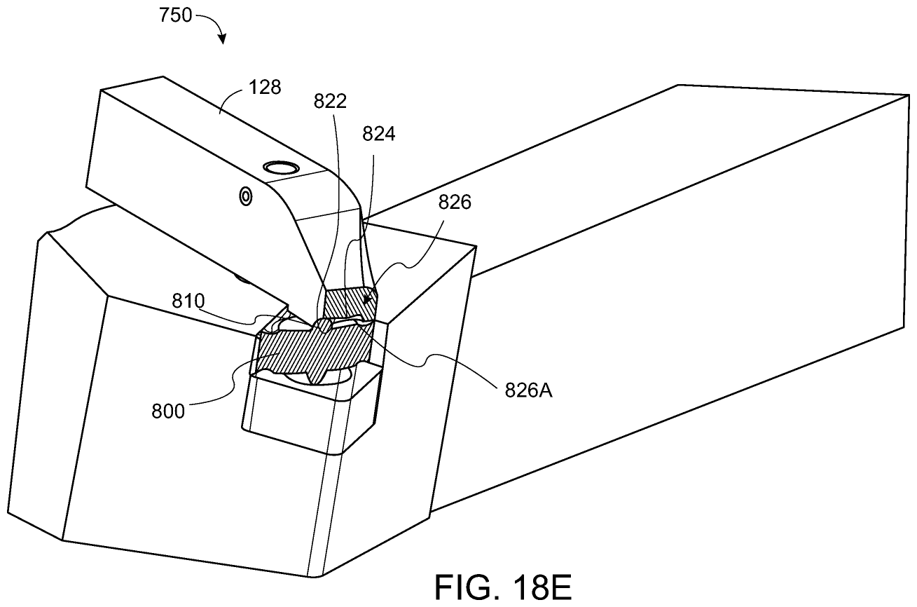

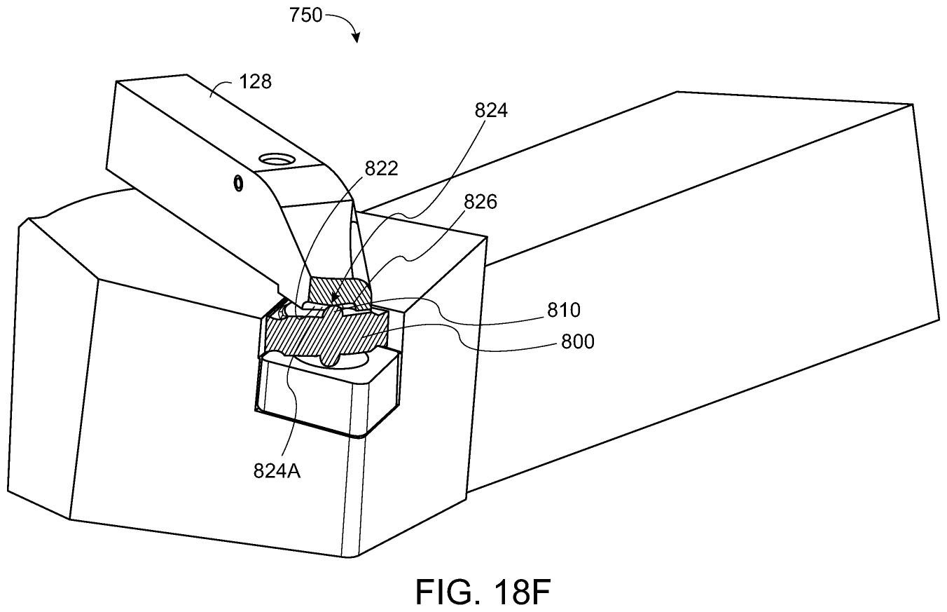

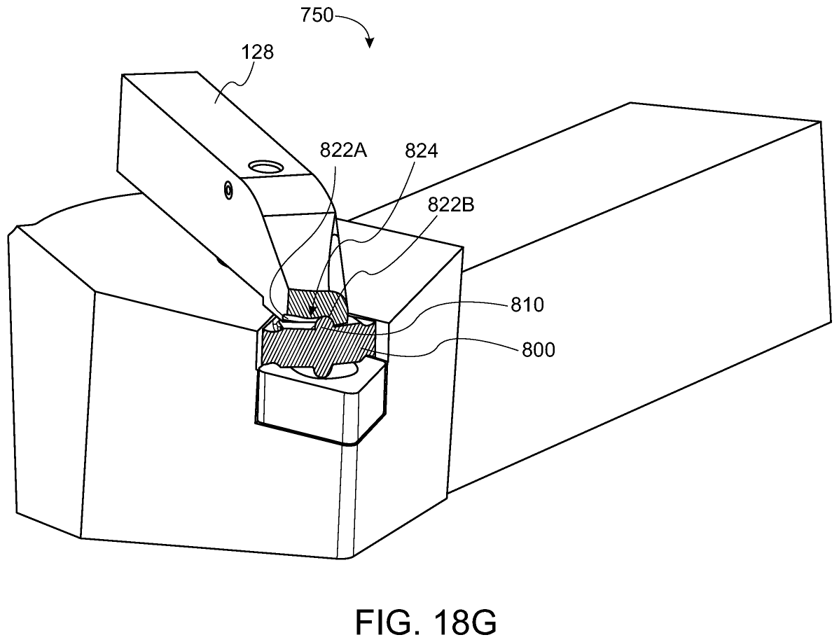

Reference is made to FIGS. 18A-G, which are different perspective views of a cutting tool holder system 750 in its unclamping mode (18A), clamping mode (18D and 18G), intermediate modes between the clamping and unclamping modes (18B, 18C, 18E, and 18F).

As seen in FIGS. 18A-18G, a cutting insert 800 defining a top surface 802 (interchangeably used herein with insert top surface) formed with at least one protrusion 810 protruding from the top surface 802. The protrusion 810 can be integrally formed with the cutting insert 800 or can be a top portion of a rod extending at least partially through the cutting insert 800 (for example, as described with respect to FIGS. 16A and 16B). It is to be understood herein that the top surface of the cutting insert is intended to signify the surface facing the clamp when the cutting insert is positioned in the seat for operation thereof. It is to be understood herein that the clamp 128 of the cutting tool holder system 750 is configured to operate in the same manner for clamping and unclamping the cutting insert as described herein for all the examples described above.

In general, the protrusion 810 is arranged at any location on the top surface 802 and is aligned with a recess 820 formed in the cutting insert-engaging portion 134 of clamp 128, namely at an underside of the cutting insert-engaging portion 134.

In some examples, the protrusion 810 is positioned at least at the midpoint of the top surface 802.

In general, the protrusion 810 is formed as a hemisphere extending from the top surface 802 for being received at least partially within the recess 820. For instance, the protrusion 802 has a height dimensioned to least partially protrude axially above the clamp-facing surface 140 when the cutting insert 800 is seated within the seat. In some examples, the protrusion 810 can be formed to have other shapes.

As can be best seen in FIG. 18E-G, the recess 820 has a bottom surface 822 that engages the protrusion top to apply the clamping force on the protrusion 810 and thus on the cutting insert 800. The bottom surface 822 extends between an open end 822A and a closed end 822B, and includes a middle region 824 which has a depth lesser than the surrounding regions, thereby forming a depression 826 between the middle region 824 and the closed end 822B corresponding to the location at which the protrusion will be placed at the clamping mode (as shown in FIG. 18G). The depression 826 locks the protrusion 810 therewithin and includes inclined walls 826A that constitute guiding surfaces for the protrusion 810 for guiding the protrusion 810 into the depression 826 in an event of inadvertent movement of the protrusion 810 (or the cutting insert 800) and the clamp 128 with respect to each other. For instance, the inadvertent movements can occur during cutting operation, and in such events, the protrusion 810 does not fall out of the recess 820 due to the depression 826. In other words, in the event of inadvertent movements, the depression 826 prevents the inadvertent rotation of the clamp 128 into the unclamping mode, thereby preventing accidental removal of the cutting insert 800 from the seat.

Due to the depression 826, a minimum amount of rotational force is required to rotate the clamp from the clamping position to the unclamping position to bring the protrusion 810 out of the depression 826. When the clamp 128 is rotated from the unclamping position to the clamping position, first the open end 822A of the recess 820 moves over the protrusion 810 thereby receiving the protrusion within the recess 820, as shown in an intermediate mode in FIGS. 18B and 18E. A further rotation causes an inclined wall portion 824A between the middle region 824 and the open end 822A to engage the protrusion 810 to thereby lift the clamp 128 away from the cutting insert 800, as shown in another intermediate mode in FIGS. 18C and 18F, until the middle region 824 crosses the protrusion 810. Further rotational movement causes the clamp 128 to fall (due to the compression force) towards the cutting insert 800 and the depression 826 to fall onto the protrusion 810 thereby locking the protrusion 810 in the depression 826, as shown in the clamping mode in FIGS. 18D and 18G.

When the clamp 128 is rotated from the clamping position to the unclamping position, the inclined wall portion 826A of the depression 826 (extending towards the middle region 824) engages with the protrusion 810 and causes the clamp 128 to lift upwards away from the cutting insert 800 until the middle region 824 crosses the protrusion 810. Once the middle portion 824 has crossed the protrusion 810, a further rotation of the clamp 128 causes the open end 822A to move over the protrusion 810 thereby releasing the protrusion 810 from the recess 820.

It is to be understood herein that in some examples, the portion of the recess 820 extending between the open end 822A and the middle region 824 can be formed as an inclined surface to constitute (together with the protrusion 810) an elevation arrangement to operate in the same manner as any one of the above-described examples of the elevation arrangements.

It is to be understood herein that in some examples, the recess 820 and the protrusion 810 can additionally (or alternatively) constitute an arrangement to increase the horizontal component of the clamping force. For instance, the curvature of the recess about the axis of rotation can be different from the curvature of the rotational movement of the clamp, in the same manner as described herein above with respect to the arrangements for increasing the horizontal component of the clamping force and operate in the same manner.

Reference is made to FIGS. 19A and 19B, which are a perspective view of the clamp 128 at an underside thereof (19A) and a perspective view of the body 104 (19B), illustrating yet another example of the elevation arrangement.

As seen in FIGS. 19A and 19B, an elevation arrangement 400 comprises a pair comprising a first surface (e.g., inclined surface 264 shown in FIG. 19B) formed on the top surface (the surface facing the clamp) of the cutting insert 124 and a second surface (e.g. vertically adjacent surface, shown here as the protrusion 276 in FIG. 19A) formed on the underside surface of the cutting insert engaging portion 134. In the shown example, the inclined surface 264 carved in the top surface of the cutting insert 124 and the protrusion formed on the underside surface of the cutting insert engaging portion 134, and are configured to operate in the same manner as the elevation arrangements described above with respect to FIGS. 5 to 13B.

During the clamping mode the protrusion 276 is positioned within the deeper region 270 of the inclined surface 264. When the clamp 128 is rotated from the clamping mode to the unclamping mode, the protrusion moves towards the superficial region 272, which is flush with the top surface of the insert, and is elevated because of the slope of the inclined surface 264. A further rotation causes the protrusion 276 to move completely off the cutting insert thereby allowing the cutting insert 124 to be removed, as described hereinabove.

It is to be understood herein that in some examples, the inclined surface 264 and the protrusion 276 can additionally (or alternatively) constitute an arrangement to increase the horizontal component of the clamping force. For instance, the curvature of the inclined surface about the axis of rotation can be different from the curvature of the rotational movement of the clamp, in the same manner as described herein above with respect to the arrangements for increasing the horizontal component of the clamping force and operate in the same manner.

1-47. (canceled)

48. A cutting tool holder system operative for securely mounting thereon a cutting insert for performing a cutting operation thereby, said cutting tool holder system, at least when assembled for operation, comprising:
(a) a cutting tool holder having a body with a seat configured for mounting the cutting insert thereon;
(b) a clamp having a cutting insert-engaging portion and rotatably mounted to the cutting tool holder, the clamp being rotatably maneuverable between a clamping position, in which the clamp is operable to apply a clamping force at least on the cutting insert positioned within the seat for preventing removal of the cutting insert from the seat, and an unclamping position, in which the clamp allows the removal of the insert from the seat, the body of the cutting tool holder having a clamp-facing surface facing the clamp;
(c) a compression unit configured for facilitating application of a compression force on the clamp towards the cutting tool holder, to enable the clamp to apply said clamping force at least while the clamp is positioned in the clamping position; and
(d) a rotation unit configured for enabling the clamp to move in a rotational motion with respect to the cutting tool holder between the clamping position and the unclamping position, by application of a rotational force of a magnitude compatible with that of a user's manual force; and
(e) an elevation arrangement for elevating the cutting insert-engaging portion above the clamp-facing surface during rotation of the clamp by the rotation unit,
(f) the elevation arrangement comprising an inclined surface and a vertically adjacent surface which are other than thread surfaces, and which are configured to engage each other in one of the following manners:
the inclined surface is positioned at least partially codirectionally with at least a part of the rotational motion of the clamp when maneuvered between the clamping position and the unclamping position and configured to engage the vertically adjacent surface; or
the vertically adjacent surface is configured to engage the inclined surface so as to advance therealong during the rotational motion of the clamp when maneuvered between the clamping position and the unclamping position.

49. The cutting tool holder system according to claim 48, wherein the compression unit is operable to be compressed to a first extent in which the compression unit has a first length while the clamp is positioned in the clamping position and to be compressed to a second extent at which the compression unit has a second length, while the clamp is positioned in the unclamping position, and the second extent is similar or greater than the first extent.

50. The cutting tool holder system according to claim 48, wherein the compression unit comprises any one of a compression spring element, a piston, a mechanical fastener, or a ratchet mechanism.

51. The cutting tool holder system according to claim 48, wherein the body of the cutting tool holder is formed with a cavity therein, wherein the compression unit is positioned at least partially within the cavity.

52. The cutting tool holder system according to claim 51, wherein the cavity has a wide portion forming a peripheral first shoulder and extending to a narrow portion forming a peripheral second shoulder, wherein the compression unit is confined at least partially intermediate the peripheral first shoulder and the peripheral second shoulder.

53. The cutting tool holder system according to claim 48, wherein the inclined surface is sloped so as to increasingly rise in a direction extending from the clamp-facing surface to the clamp and codirectionally with at least a part of the rotational motion of the clamp when maneuvered from the clamping position towards the unclamping position.

54. The cutting tool holder system according to claim 53, wherein the inclined surface is defined on the clamp or at the cutting tool holder and the vertically adjacent surface is defined at the oppositely positioned cutting tool holder or the clamp.

55. The cutting tool holder system according to claim 54, wherein the clamp defines a lower surface facing the cutting tool holder, and wherein the inclined surface is positioned at any one of: the lower surface or the clamp-facing surface.

56. The cutting tool holder system according to claim 48, wherein the inclined surface comprises a deeper region associated with the clamping position of the clamp and a superficial region associated with the unclamping position of the clamp, and the vertically adjacent surface comprises at least one protrusion protruding towards the inclined surface.

57. The cutting tool holder system according to claim 56, wherein when the clamp is positioned at the clamping position the protrusion is disposed in the deeper region and when the clamp is positioned at the unclamping position the protrusion is disposed at the superficial region or closer to the superficial region than to the deeper region.

58. The cutting tool holder system according to claim 48, wherein the inclined surface has a curvature about an axis of rotation of the clamp, said curvature of the inclined surface being different from a curvature of the rotational motion of the clamp about the axis of rotation.

59. The cutting tool holder system according to claim 48, wherein the cutting insert has an insert top surface and the inclined surface constitutes a protrusion protruding from the insert top surface and configured to at least partially engage with a corresponding recess formed on the clamp.

60. The cutting tool holder system according to claim 48, wherein the clamp is formed with at least one depression configured for positioning the user's finger on the clamp so as to apply the rotational force utilizing the user's manual force.

61. The cutting tool holder system according to claim 48, wherein the rotational motion is operable by application of the user's manual force without use of a tool.

62. The cutting tool holder system according to claim 51, wherein the clamp is formed with a bore positioned substantially orthogonally to the clamp-facing surface and in alignment with the cavity.

63. The cutting tool holder system according to claim 62, wherein the rotation unit comprises an axle operable to be inserted within the bore and the cavity, and the axle is configured for rotating the clamp in the rotational motion.

64. The cutting tool holder system according to claim 48, wherein the rotation unit comprises a friction mitigating member for mitigating friction resulting from the compression force applied on the clamp by the compression unit, thereby facilitating the rotational motion.

65. The cutting tool holder system according to claim 48, wherein the rotation unit comprises a helical rotation unit configured for enabling the clamp to move in a helical rotational motion with respect to the cutting tool holder between the clamping position and the unclamping position, by application of the rotational force, the helical motion vertically distancing the cutting insert-engaging portion from the body.

66. A cutting tool comprising the cutting tool holder system according to claim 48, and a cutting insert.

67. A method for selectively mounting a cutting insert on a seat formed within a body of a cutting tool holder during a clamping mode and dismounting the cutting insert from the seat during an unclamping mode, the body being formed with a clamp-facing surface configured to face a clamp having a cutting insert-engaging portion, and is provided with an elevation arrangement comprising an inclined surface configured to engage a vertically adjacent surface, the inclined surface being positioned at least partially codirectionally with at least a part of the rotational motion of the clamp when maneuvered between the clamping position and the unclamping position and the inclined surface and vertically adjacent surface being other than thread surfaces, the method comprising:
(a) seating the cutting insert in the seat;
(b) applying a compression force on the clamp towards the cutting tool holder during both the clamping mode and the unclamping mode;
(c) clamping the cutting insert during the clamping mode to the seat by applying a clamping force via the cutting insert-engaging portion of the clamp at least on the cutting insert, thereby preventing removal of the cutting insert from the seat,
wherein the clamping force is facilitated by the compression force; and
(d) unclamping the cutting insert during the unclamping mode by rotating the clamp with respect to the cutting tool holder with a rotational force of a magnitude compatible with that of a user's manual force, wherein during the rotation of the clamp, the cutting insert-engaging portion of the clamp is elevated above the clamp-facing surface by said elevation arrangement during rotation of the clamp by the rotation unit, and
(e) engaging the vertically adjacent surface by the inclined surface for advancing along the inclined surface during the rotational motion.

68. A cutting tool holder system operative for securely mounting thereon a cutting insert for performing a cutting operation thereby, said cutting tool holder system, at least when assembled for operation, comprising:
(a) a cutting tool holder having a body with a seat configured for mounting the cutting insert thereon;
(b) a clamp having a cutting insert-engaging portion and rotatably mounted to the cutting tool holder, the clamp being rotatably maneuverable between a clamping position, in which the clamp is operable to apply a clamping force at least on the cutting insert positioned within the seat for preventing removal of the cutting insert from the seat, and an unclamping position, in which the clamp allows the removal of the cutting insert from the seat;
(c) a compression unit configured for facilitating application of a compression force on the clamp towards the cutting tool holder, to enable the clamp to apply said clamping force at least while the clamp is positioned in the clamping position; and
(d) a rotation unit configured for enabling the clamp to move in a rotational motion with respect to the cutting tool holder between the clamping position and the unclamping position, by application of a rotational force of a magnitude compatible with that of a user's manual force;
wherein the clamp comprises a clamp-rear portion, which is located horizontally opposite the cutting insert-engaging portion, and the body comprises a body-rear portion which is located horizontally opposite the seat, and
wherein an extension extends from one of the clamp-rear portion and the body-rear portion and is configured to slidably move along the other one of the body-rear portion and the clamp-rear portion during the rotational motion.

69. The cutting tool holder system according to claim 68, wherein the other one of the body-rear portion and the clamp-rear portion comprises a groove having a wall and the wall is configured for the slidable movement of the extension during the rotational motion.

70. The cutting tool holder system according to claim 69, wherein the groove has a curvature about an axis of rotation of the clamp, said curvature of the groove being different from a curvature of the rotational motion of the clamp about the axis of rotation.

71. The cutting tool holder system according to claim 70, wherein the curvature of the groove causes the clamp to at least tend to move in a direction extending from the seat towards the body-rear portion during rotation of the clamp from the unclamping position to the clamping position.

72. A method for selectively mounting a cutting insert on a seat formed within a body of a cutting tool holder during a clamping mode and dismounting the cutting insert from the seat during an unclamping mode, the body being formed with a body-rear portion which is located horizontally opposite the seat, a clamp-facing surface configured to face a clamp having a cutting insert-engaging portion, and the clamp having a clamp-rear portion, which is located horizontally opposite the cutting insert-engaging portion, the method comprising:
(a) seating the cutting insert in the seat;
(b) applying a compression force on the clamp towards the cutting tool holder during both the clamping mode and the unclamping mode;
(c) clamping the cutting insert during the clamping mode to the seat by applying a clamping force via the cutting insert-engaging portion of the clamp at least on the cutting insert, thereby preventing removal of the cutting insert from the seat,
wherein the clamping force is facilitated by the compression force;
(d) unclamping the cutting insert during the unclamping mode by rotating the clamp with respect to the cutting tool holder with a rotational force of a magnitude compatible with that of a user's manual force,
wherein an extension extends from one of the clamp-rear portion and the body-rear portion and is configured to slidably move along the other one of the body-rear portion and the clamp-rear portion during the rotational motion.
